(19) United States
(12) Patent Application Publication
(10) Pub. No.: US 2009/0115981 A1
(43) Pub. Date: May 7, 2009

(54) DRAWING POINT DATA OBTAINMENT METHOD AND APPARATUS AND DRAWING METHOD AND APPARATUS

(75) Inventor: Mitsuru Mushano, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/910,253

(22) PCT Filed: Mar. 29, 2006
(86) PCT No.: PCT/JP2006/306493

§ 371 Date: Sep. 28, 2007

(30) Foreign Application Priority Data
Mar. 31, 2005 (JP) 2005-103787

(51) Int. Cl. G03B 27/68

(52) U.S. Cl. 355/52

(57) ABSTRACT

A drawing point data obtainment method is a method for obtaining drawing point data that is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object. In the drawing point data obtainment method, information about a drawing point data track of the drawing point formation area in original image data of the image is obtained and a plurality of drawing point data sets corresponding to the drawing point data track is obtained, based on the obtained information about the drawing point data track, from the image data.

### CROSS REFERENCE TO RELATED APPLICATIONS

This application is a National Stage of International Application No. PCT/JP2006/306493 filed on Mar. 29, 2006, claiming priority based on Japanese Patent Application No. 2005-103787, filed arch 31, 2005, the contents of all of which are incorporated herein by reference in their entirety.

### TECHNICAL FIELD

The present invention relates to a drawing method and apparatus for drawing an image by relatively moving a drawing point formation area, in which a drawing point is formed based on drawing point data, with respect a substrate (base plate, board, plate or the like) and by sequentially forming drawing points based on the movement of the drawing point formation area. Further, the present invention relates to a drawing point data obtainment method and apparatus for obtaining drawing point data that is used in the drawing method and apparatus.

### BACKGROUND ART

Conventionally, various kinds of exposure apparatuses using photolithography techniques have been proposed as apparatuses for recording predetermined patterns on substrates of printed wiring boards (printed circuit boards) or flat panel displays.

As such exposure apparatuses, an exposure apparatus that forms a circuit pattern by scanning a substrate that has been coated with photoresist with a light beam in a main scan direction and in a sub-scan direction and by modulating the light beam based on image data representing the circuit pattern has been proposed, for example.

Further, as the aforementioned exposure apparatus, various kinds of exposure apparatuses that perform exposure by using a spatial light modulation device, such as a digital micromirror device (hereinafter, referred to as a DMD), and by modulating, based on image data, a light beam by the spatial light modulation device have been proposed, for example.

As the exposure apparatus using a DMD, as described, an exposure apparatus that forms a desirable image on an exposure plane by relatively moving the DMD in a predetermined direction with respect to the exposure plane, by inputting, based on the movement of the DMD in the scan direction, frame data including a multiplicity of drawing point data sets corresponding to a multiplicity of micromirrors to memory cells of the DMD, and by sequentially forming a group of drawing points corresponding to the micromirrors of the DMD in time series has been proposed, for example (please refer to Japanese Unexamined Patent Publication No. 2004-233718, for example).

Meanwhile, circuit patterns to be formed on printed circuit boards by the aforementioned exposure apparatuses are becoming thinner and finer. Therefore, for example, when a multilayer printed circuit board is produced, it is necessary to perform highly accurate positioning of a circuit pattern of each layer.

### DISCLOSURE OF THE INVENTION

### Problems to be Solved by the Invention

Since the aforementioned positioning is performed, exposure is performed in such a manner that a circuit pattern of each layer is formed at a position that has been set in advance with respect to the substrate. However, when a multilayer printed circuit board is produced, the substrate is heated in a press process, in which layers are attached to each other. Therefore, the substrate is deformed by heat in some cases. Hence, if exposure is performed so that the circuit pattern of each layer is formed at a position that has been set in advance, as described above, there is a risk that the recording position of the circuit pattern of each layer may be shifted (the circuit pattern of each layer may not be recorded at an intended position) and highly accurate positioning of the circuit pattern of each layer may become difficult.

Further, when exposure is performed to form a color filter pattern in a flat panel display, the substrate of the flat panel display is heated. Therefore, there is a risk that the substrate may expand or shrink (contract) by the heat and the recording position of each of R, G and B colors may be shifted (each of R, G and B colors may not be recorded at an intended position).

Further, for example, when a substrate is scanned with a light beam by moving the substrate in a predetermined scan direction, the direction of the movement of the substrate may be shifted (the substrate may not move in an intended direction), in some cases, depending on the control accuracy of a movement mechanism for moving the substrate. If the movement direction is shifted, there is a risk that highly accurate positioning of the circuit pattern or the like may become difficult.

In view of the foregoing circumstances, it is an object of the present invention to provide a drawing method and apparatus for drawing a desirable image at a desirable position on a substrate without being affected by deformation of the substrate, a shift in the direction of the movement of the substrate or the like in the drawing method and apparatus, such as the aforementioned exposure apparatus. Further, it is another object of the present invention to provide a method and apparatus for obtaining drawing point data to be used in the drawing method and apparatus.

### Means for Solving the Problems

A first drawing point data obtainment method of the present invention is a drawing point data obtainment method for obtaining drawing point data that is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object. The method is characterized in that information about a drawing point data track (path or route) of the drawing point formation area in original image data of the image is obtained and a plurality of drawing point data sets corresponding to the drawing point data track are obtained, based on the obtained information about the drawing point data track, from the image data.

A second drawing point data obtainment method of the present invention is a drawing point data obtainment method for obtaining drawing point data that is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object. The method is characterized in that information about a drawing track of the drawing point formation area on the drawing object is obtained, the drawing track being a drawing track when the image is drawn, and information about a drawing point data track of the drawing point formation area in original image data of the image is obtained based on the obtained information about the drawing track, and a plurality of drawing point data sets corresponding to the drawing point data track are obtained, based on the obtained information about the drawing point data track, from the image data.

A third drawing point data obtainment method of the present invention is a drawing point data obtainment method for obtaining drawing point data that is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object. The method is characterized in that information about a drawing track of the drawing point formation area in an image space on the drawing object is obtained, and information about a drawing point data track of the drawing point formation area in original image data of the image is obtained based on the obtained information about the drawing track, and a plurality of drawing point data sets corresponding to the drawing point data track are obtained, based on the obtained information about the drawing point data track, from the image data.

Further, in the second and third drawing point data obtainment methods of the present invention, detection position information indicating the positions of a plurality of base marks and/or base portions present at predetermined positions on the drawing object may be obtained by detecting the plurality of base marks and/or base portions, and the information about the drawing track may be obtained based on the obtained detection position information.

Further, shift information about an actual relative movement direction and/or movement posture of the drawing object at the time of drawing the image with respect to a predetermined relative movement direction and/or movement posture of the drawing object may be obtained. The predetermined relative movement direction and/or movement posture are a direction and/or posture that have been set in advance. Then, the information about the drawing track may be obtained based on the obtained shift information.

Further, shift information about an actual relative movement direction and/or movement posture of the drawing object at the time of drawing the image with respect to a predetermined relative movement direction and/or movement posture of the drawing object may be obtained. The predetermined relative movement direction and/or movement posture are a direction and/or posture that have been set in advance. Then, the information about the drawing track may be obtained based on the obtained shift information and the detection position information.

Further, the number of drawing point data sets obtained from each pixel data set forming the image data may be changed based on the length of a drawing track indicated by the information about the drawing track.

Further, in the first through third drawing point data obtainment methods of the present invention, speed fluctuation information indicating the fluctuation of an actual relative movement speed of the drawing object at the time of drawing the image with respect to a predetermined relative movement speed of the drawing object may be obtained. The predetermined relative movement speed is a speed that has been set in advance. Then, the drawing point data may be obtained, based on the obtained speed fluctuation information, from each pixel data set forming the image data in such a manner that a greater number of drawing point data sets is obtained from the pixel data set for a drawing area on the drawing object as the actual relative movement speed of the drawing object is relatively slower.

Further, the drawing point data obtainment methods may be drawing point data obtainment methods, in which the drawing point data that is used at the time of drawing the image by use of a plurality of drawing point formation areas is obtained. In the drawing point data obtainment methods, the drawing point data may be obtained for each of the drawing point formation areas.

Further, the drawing point formation area may be a beam spot formed by a spatial light modulation device.

Further, a pitch component may be attached to the information about the drawing point data track, the pitch component indicating an obtainment pitch of the drawing point data.

Further, a plurality of drawing point formation areas may be present, and a single information set about the drawing point data track may be obtained for every two or more drawing point formation areas.

Further, the plurality of drawing point formation areas may be two-dimensionally arranged.

A first drawing method of the present invention is a drawing method for drawing an image on a drawing object by relatively moving a drawing point formation area, in which a drawing point is formed based on drawing point data, with respect to the drawing object and by sequentially forming, based on the movement of the drawing point formation area, the drawing points on the drawing object. The method is characterized in that information about a drawing point data track of the drawing point formation area in original image data of the image is obtained, and a plurality of drawing point data sets corresponding to the drawing point data track are obtained, based on the obtained information about the drawing point data track, from the image data, and the drawing points are formed on the drawing object based on the obtained drawing point data by use of the drawing point formation area.

A second drawing method of the present invention is a drawing method for drawing an image on a drawing object by relatively moving a drawing point formation area, in which a drawing point is formed based on drawing point data, with respect to the drawing object and by sequentially forming, based on the movement of the drawing point formation area, the drawing points on the drawing object. The method is characterized in that information about a drawing track of the drawing point formation area on the drawing object is obtained, the drawing track being a drawing track when the image is drawn, and information about a drawing point data track of the drawing point formation area in original image data of the image is obtained based on the obtained information about the drawing track, and a plurality of drawing point data sets corresponding to the drawing point data track are obtained, based on the obtained information about the drawing point data track, from the image data. Then, the drawing points are formed on the drawing object based on the obtained drawing point data by use of the drawing point formation area.

A third drawing method of the present invention is a drawing method for drawing an image on a drawing object by relatively moving a drawing point formation area, in which a drawing point is formed based on the drawing point data, with respect to the drawing object and by sequentially forming, based on the movement of the drawing point formation area, the drawing points on the drawing object. The method is characterized in that information about a drawing track of the drawing point formation area in an image space on the drawing object is obtained, and information about a drawing point data track of the drawing point formation area in original image data of the image is obtained based on the obtained information about the drawing track, and a plurality of drawing point data sets corresponding to the drawing point data track are obtained, based on the obtained information about the drawing point data track, from the image data. Then, the drawing points are formed on the drawing object based on the obtained drawing point data by use of the drawing point formation area.

In the second and third drawing methods of the present invention, detection position information indicating the positions of a plurality of base marks and/or base portions present at predetermined positions on the drawing object may be obtained by detecting the plurality of base marks and/or base portions, and the information about the drawing track may be obtained based on the obtained detection position information.

Further, shift information about an actual relative movement direction and/or movement posture of the drawing object at the time of drawing the image with respect to a predetermined relative movement direction and/or movement posture of the drawing object may be obtained, the predetermined relative movement direction and/or movement posture having been set in advance. Then, the information about the drawing track may be obtained based on the obtained shift information.

Further, shift information about an actual relative movement direction and/or movement posture of the drawing object at the time of drawing the image with respect to a predetermined relative movement direction and/or movement posture of the drawing object may be obtained, the predetermined relative movement direction and/or movement posture having been set in advance. Then, the information about the drawing track may be obtained based on the obtained shift information and the detection position information.

Further, the number of drawing point data sets obtained from each pixel data set forming the image data may be changed based on the length of a drawing track indicated by the information about the drawing track.

Further, in the first through third drawing methods of the present invention, speed fluctuation information indicating the fluctuation of an actual relative movement speed of the drawing object at the time of drawing the image with respect to a predetermined relative movement speed of the drawing object may be obtained, the predetermined relative movement speed having been set in advance. Then, the drawing point data may be obtained, based on the obtained speed fluctuation information, from each pixel data set forming the image data in such a manner that a greater number of drawing point data sets are obtained from the pixel data set for a drawing area on the drawing object as the actual relative movement speed of the drawing object is relatively slower.

Further, in the drawing method, the drawing may be performed by use of a plurality of drawing point formation areas, and the drawing point data may be obtained for each of the drawing point formation areas.

Further, the drawing point formation area may be a beam spot formed by a spatial light modulation device.

Further, a pitch component may be attached to the information about the drawing point data track, the pitch component indicating an obtainment pitch of the drawing point data.

Further, a plurality of drawing point formation areas may be present, and a single information set about the drawing point data track may be obtained for every two or more drawing point formation areas.

Further, the plurality of drawing point formation areas may be two-dimensionally arranged.

A first drawing point data obtainment apparatus of the present invention is a drawing point data obtainment apparatus for obtaining drawing point data that is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object. The apparatus is characterized by comprising:

a drawing point data track information obtainment means for obtaining information about a drawing point data track of the drawing point formation area in original image data of the image; and

a drawing point data obtainment means for obtaining, based on the information about the drawing point data track obtained by the drawing point data track information obtainment means, a plurality of drawing point data sets corresponding to the drawing point data track from the image data.

A second drawing point data obtainment apparatus of the present invention is a drawing point data obtainment apparatus for obtaining drawing point data that is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object. The apparatus is characterized by comprising:

a drawing track information obtainment means for obtaining information about a drawing track of the drawing point formation area on the drawing object, the drawing track being a drawing track when the image is drawn;

a drawing point data track information obtainment means for obtaining, based on the information about the drawing track obtained by the drawing track information obtainment means, information about a drawing point data track of the drawing point formation area in original image data of the image; and

a drawing point data obtainment means for obtaining, based on the information about the drawing point data track obtained by the drawing point data track information obtainment means, a plurality of drawing point data sets corresponding to the drawing point data track from the image data.

A third drawing point data obtainment apparatus of the present invention is a drawing point data obtainment apparatus for obtaining drawing point data that is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object. The apparatus is characterized by comprising:

a drawing track information obtainment means for obtaining information about a drawing track of the drawing point formation area in an image space on the drawing object;

a drawing point data track information obtainment means for obtaining, based on the information about the drawing track obtained by the drawing track information obtainment means, information about a drawing point data track of the drawing point formation area in original image data of the image; and

a drawing point data obtainment means for obtaining, based on the information about the drawing point data track obtained by the drawing point data track information obtainment means, a plurality of drawing point data sets corresponding to the drawing point data track from the image data.

The second and third drawing point data obtainment apparatuses of the present invention may further comprise a position information detection means for obtaining detection position information indicating the positions of a plurality of base marks and/or base portions present at predetermined positions on the drawing object by detecting the plurality of base marks and/or base portions. Further, the drawing track information obtainment means may obtain, based on the detection position information obtained by the position information detection means, the information about the drawing track.

The drawing point data obtainment apparatus may further comprise a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance. Further, the drawing point track information obtainment means may obtain, based on the shift information obtained by the shift information obtainment means, the information about the drawing track.

The drawing point data obtainment apparatus may further comprise a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance. Further, the drawing point track obtainment means may obtain, based on the shift information obtained by the shift information obtainment means and the detection position information obtained by the position information detection means, the information about the drawing track.

Further, the drawing point data obtainment means may change, based on the length of a drawing track indicated by the information about the drawing track, the number of drawing point data sets obtained from each pixel data set forming the image data.

The first through third drawing point data obtainment apparatuses of the present invention may further comprise a speed fluctuation information obtainment means for obtaining speed fluctuation information indicating the fluctuation of an actual relative movement speed of the drawing object at the time of drawing the image with respect to a predetermined relative movement speed of the drawing object, the predetermined relative movement speed having been set in advance. Further, the drawing point data obtainment means may obtain, based on the speed fluctuation information obtained by the speed fluctuation information obtainment means, the drawing point data from each pixel data set forming the image data in such a manner that a greater number of drawing point data sets are obtained from the pixel data set for a drawing area on the drawing object as the actual relative movement speed of the drawing object is relatively slower.

Further, a plurality of drawing point formation areas may be present, and the drawing point data obtainment means may obtain the drawing point data for each of the drawing point formation areas.

Further, the drawing point data obtainment apparatus may comprise a spatial light modulation device for forming the drawing point formation area.

Further, a pitch component may be attached to the information about the drawing point data track, the pitch component indicating an obtainment pitch of the drawing point data.

Further, a plurality of drawing point formation areas may be present, and the drawing point data track information obtainment means may obtain a single information set about the drawing point data track for every two or more drawing point formation areas.

Further, the plurality of drawing point formation areas may be two-dimensionally arranged.

A first drawing apparatus of the present invention is a drawing apparatus for drawing an image on a drawing object by relatively moving a drawing point formation area, in which a drawing point is formed based on drawing point data, with respect to the drawing object and by sequentially forming, based on the movement of the drawing point formation area, the drawing points on the drawing object. The apparatus is characterized by comprising:

a drawing point data track information obtainment means for obtaining information about a drawing point data track of the drawing point formation area in original image data of the image;

a drawing point data obtainment means for obtaining, based on the information about the drawing point data track obtained by the drawing point data track information obtainment means, a plurality of drawing point data sets corresponding to the drawing point data track from the image data; and

a drawing means for forming, based on the drawing point data obtained by the drawing point data obtainment means, the drawing points on the drawing object by use of the drawing point formation area.

Further, a second drawing apparatus of the present invention is a drawing apparatus for drawing an image on a drawing object by relatively moving a drawing point formation area, in which a drawing point is formed based on drawing point data, with respect to the drawing object and by sequentially forming, based on the movement of the drawing point formation area, the drawing points on the drawing object. The apparatus is characterized by comprising:

a drawing track information obtainment means for obtaining information about a drawing track of the drawing point formation area of the image on the drawing object;

a drawing point data track information obtainment means for obtaining, based on the information about the drawing track obtained by the drawing track information obtainment means, information about a drawing point data track of the drawing point formation area in original image data of the image;

a drawing point data obtainment means for obtaining, based on the information about the drawing point data track obtained by the drawing point data track information obtainment means, a plurality of drawing point data sets corresponding to the drawing point data track from the image data; and

a drawing means for forming, based on the drawing point data obtained by the drawing point data obtainment means, the drawing points on the drawing object by use of the drawing point formation area.

A third drawing apparatus of the present invention is a drawing apparatus for drawing an image on a drawing object by relatively moving a drawing point formation area, in which a drawing point is formed based on drawing point data, with respect to the drawing object and by sequentially forming, based on the movement of the drawing point formation area, the drawing points on the drawing object. The apparatus is characterized by comprising:

a drawing track information obtainment means for obtaining information about a drawing track of the drawing point formation area in an image space on the drawing object;

a drawing point data track information obtainment means for obtaining, based on the information about the drawing track obtained by the drawing track information obtainment means, information about a drawing point data track of the drawing point formation area in original image data of the image;

a drawing point data obtainment means for obtaining, based on the information about the drawing point data track obtained by the drawing point data track information obtainment means, a plurality of drawing point data sets corresponding to the drawing point data track from the image data; and

a drawing means for forming, based on the drawing point data obtained by the drawing point data obtainment means, the drawing points on the drawing object by use of the drawing point formation area.

The second and third drawing apparatuses of the present invention may further comprise a position information detection means for obtaining detection position information indicating the positions of a plurality of base marks and/or base portions present at predetermined positions on the drawing object by detecting the plurality of base marks and/or base portions. Further, the drawing track information obtainment means may obtain, based on the detection position information obtained by the position information detection means, the information about the drawing track.

The drawing apparatus may further comprise a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance. Further, the drawing point track information obtainment means may obtain, based on the shift information obtained by the shift information obtainment means, the information about the drawing track.

Further, the drawing apparatus may further comprise a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance. Further, the drawing point track obtainment means may obtain, based on the shift information obtained by the shift information obtainment means and the detection position information obtained by the position information detection means, the information about the drawing track.

The drawing point data obtainment means may change, based on a length indicated by the information about the drawing track, the number of drawing point data sets obtained from each pixel data set forming the image data.

Further, the first through third drawing apparatuses of the present invention may further comprise a speed fluctuation information obtainment means for obtaining speed fluctuation information indicating the fluctuation of an actual relative movement speed of the drawing object at the time of drawing the image with respect to a predetermined relative movement speed of the drawing object, the predetermined relative movement speed having been set in advance. Further, the drawing point data obtainment means may obtain, based on the speed fluctuation information obtained by the speed fluctuation information obtainment means, the drawing point data from each pixel data set forming the image data in such a manner that a greater number of drawing point data sets are obtained from the pixel data set for a drawing area on the drawing object as the actual relative movement speed of the drawing object is relatively slower.

Further, a plurality of drawing point formation areas may be present, and the drawing point data obtainment means may obtain the drawing point data for each of the drawing point formation areas.

Further, the drawing apparatus may comprise a spatial light modulation device for forming the drawing point formation area.

Further, a pitch component may be attached to the information about the drawing point data track, the pitch component indicating an obtainment pitch of the drawing point data.

Further, a plurality of drawing point formation areas may be present, and the drawing point data track information obtainment means may obtain a single information set about the drawing point data track for every two or more drawing point formation areas.

Further, the plurality of drawing point formation areas may be two-dimensionally arranged. The “drawing point formation area (or areas)” may be formed by any kind of area (or areas) as long as drawing points are formed on a substrate by use of the area (or areas). For example, the drawing point formation area may be a beam spot formed by beam light reflected by each modulation element of a spatial light modulation device, such as a DMD. Alternatively, the drawing point formation area may be a beam spot formed by beam light itself emitted from a light source. Alternatively, the drawing point formation area may be an area to which ink ejected from each nozzle of an inkjet printer attaches.

### EFFECTS OF THE INVENTION

According to the first through third drawing point data obtainment methods and apparatuses of the present invention and the first through third drawing methods and apparatuses of the present invention, information about a drawing point data track of a drawing point formation area in image data representing an image is obtained, and a plurality of drawing point data sets corresponding to the drawing point data track are obtained, based on the obtained information about the drawing point data track, from the image data. Therefore, for example, if information about the drawing track of the drawing point formation area on a substrate or in its image space is obtained in advance, the drawing track being a drawing track at the time of drawing an image, and if the information about the drawing point data track is obtained based on the information about the drawing track, even if the substrate is deformed or the position of the substrate is shifted for example, it is possible to draw an image on the substrate based on the deformation and the shift of the position of the substrate. The image can be drawn on the substrate in such a manner because information about the drawing track of the drawing point formation area on the substrate or in the image space is obtained in advance and it is possible to obtain drawing point data corresponding to the information about the drawing track from the image data. In this case, for example, when a multilayer printed circuit board is produced, a circuit pattern of each layer can be formed based on the deformation of each layer. Hence, it is possible to correctly position the circuit pattern of each layer.

Further, for example, when the substrate is scanned with a light beam by moving the substrate in a predetermined scan direction, as described above, even if the direction of the movement of the substrate is shifted, it is possible to draw a desirable image at a desirable position on the substrate without being affected by the shift in the movement direction. The desirable image is formed in such a manner because information about the drawing track based on the shift in the movement direction is obtained in advance and it is possible to obtain drawing point corresponding to the information about the drawing track from the image data.

Further, it is possible to obtain drawing point data by calculating addresses of a memory storing image data along the drawing point data track. Therefore, it is possible to easily calculate the addresses.

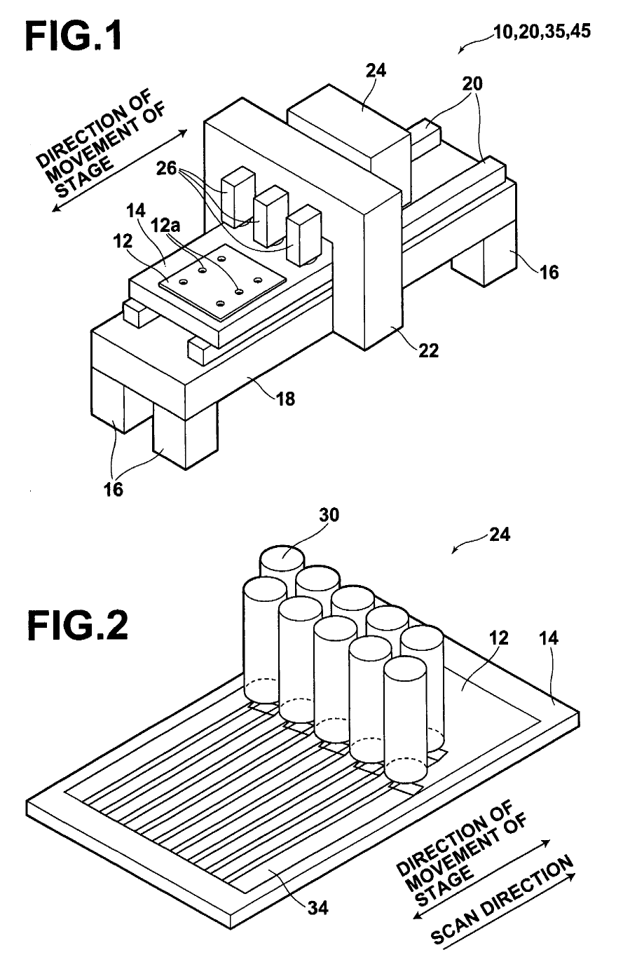

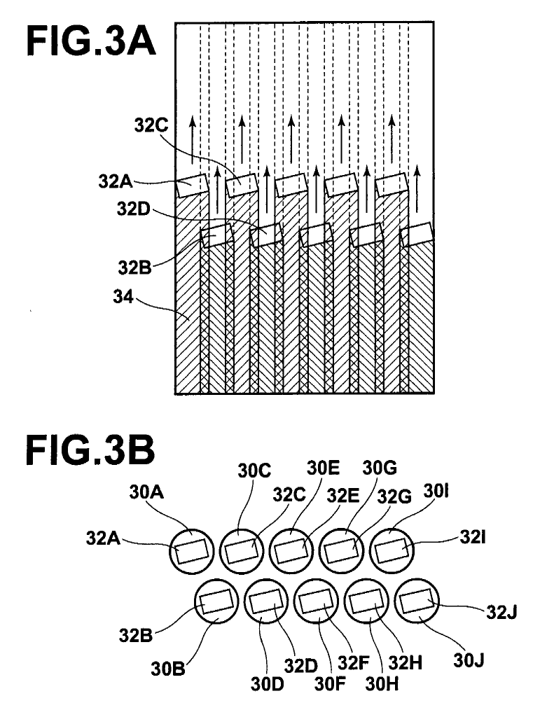

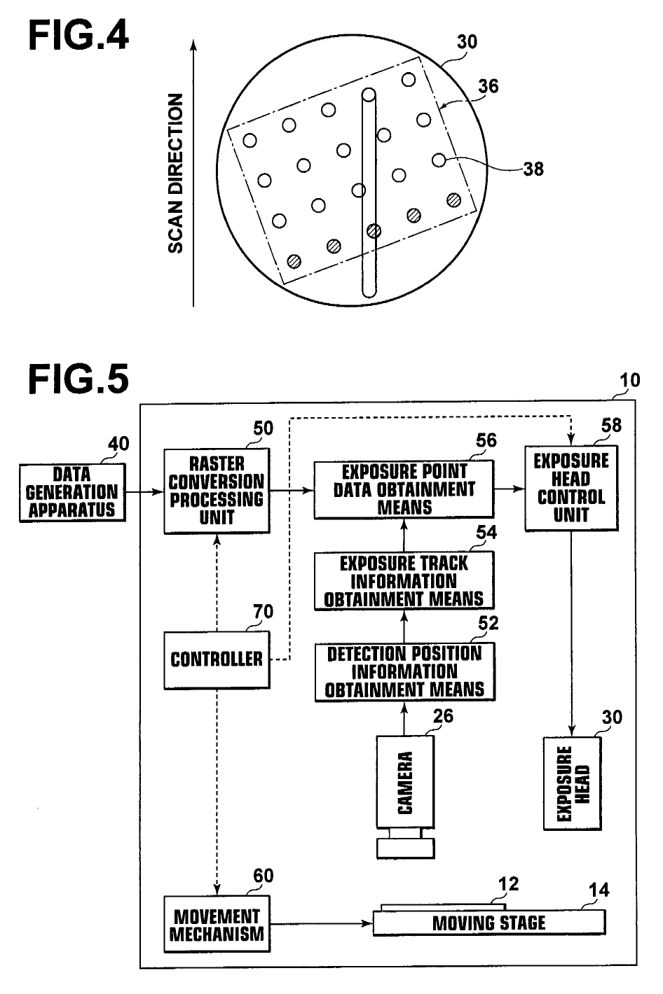

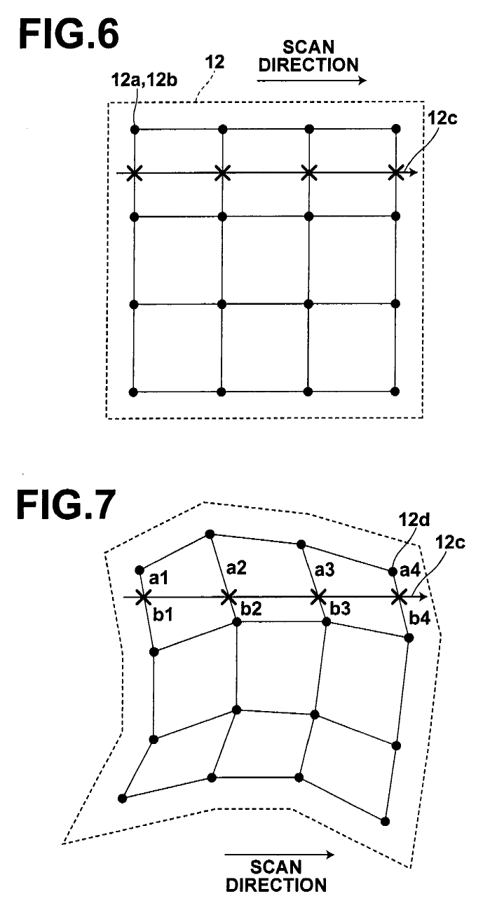

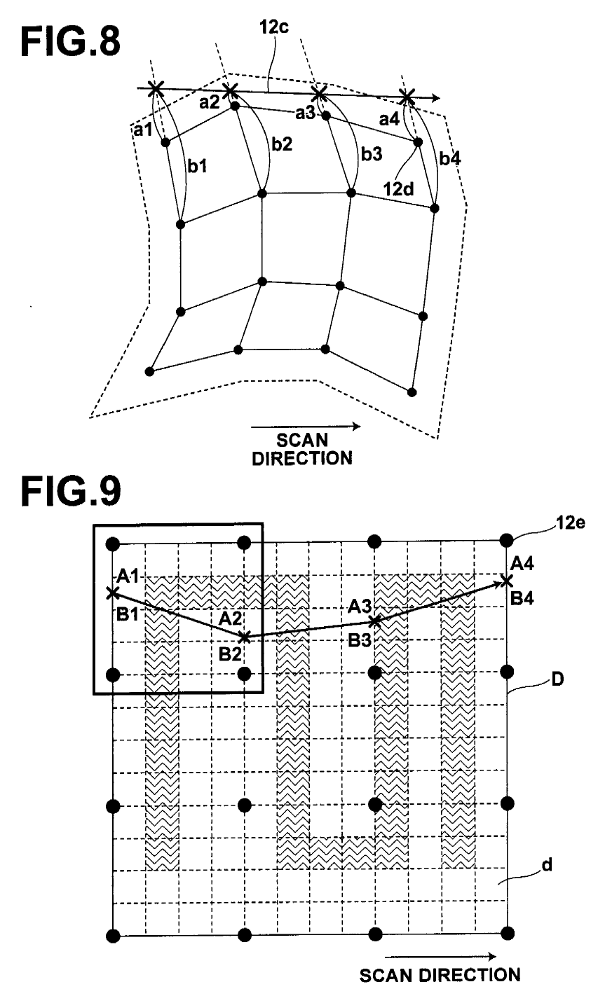

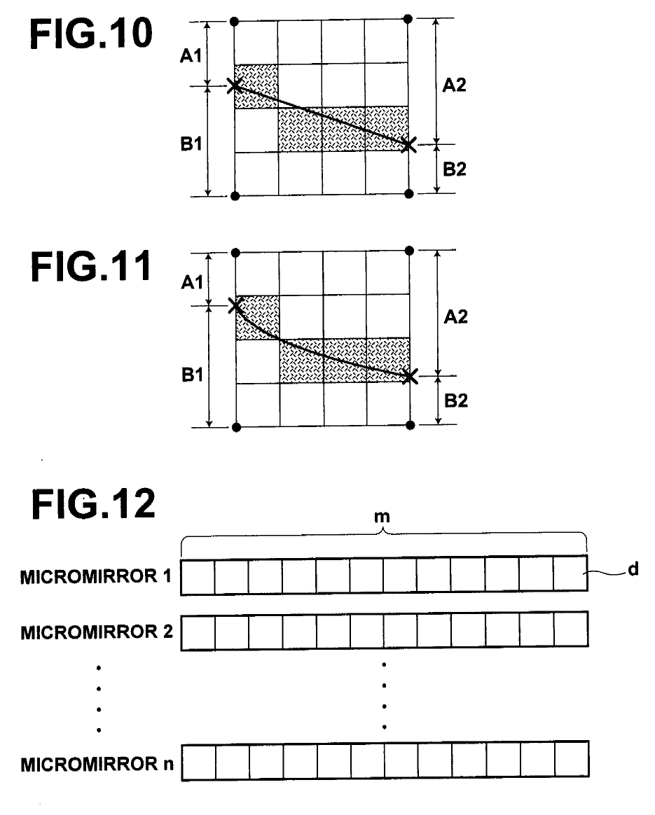

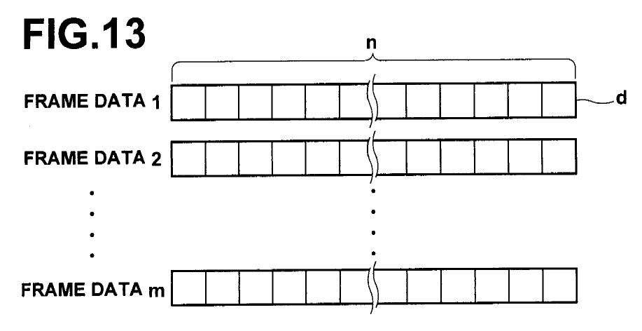

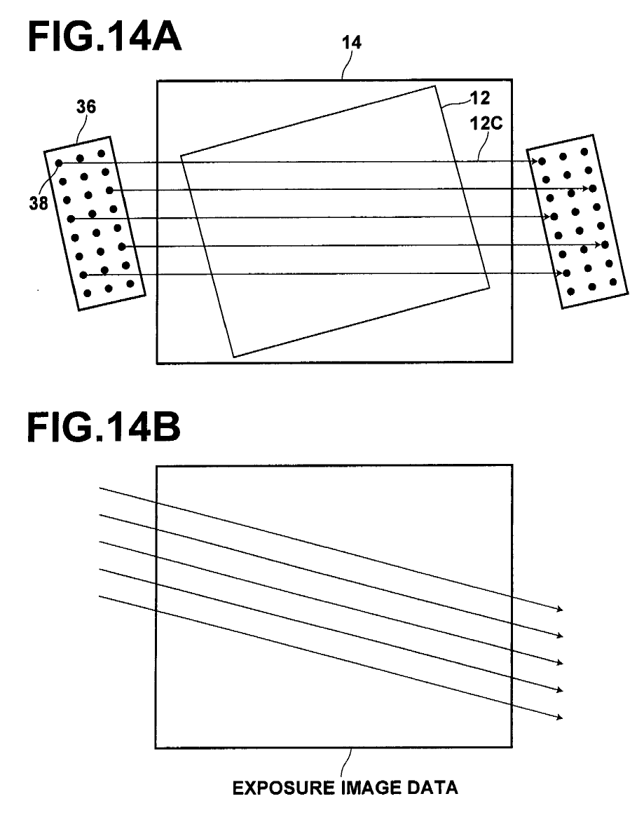

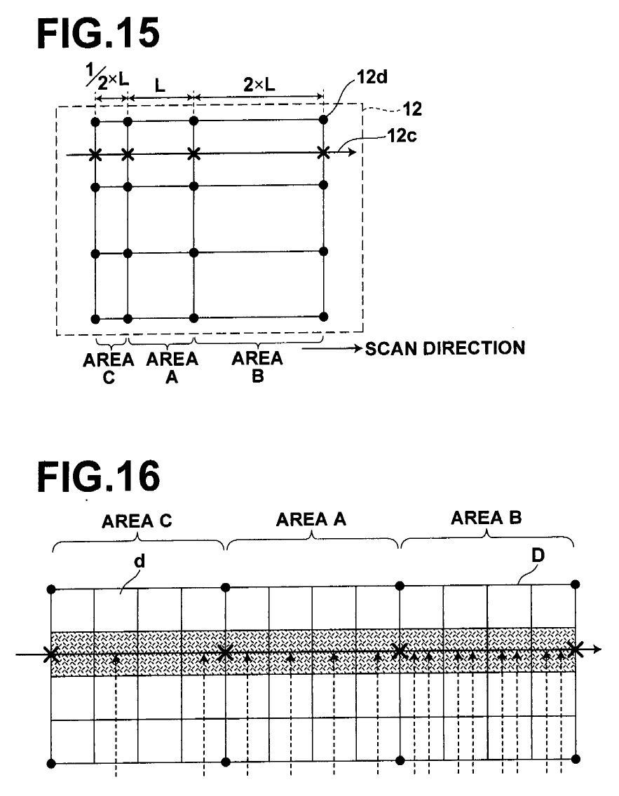

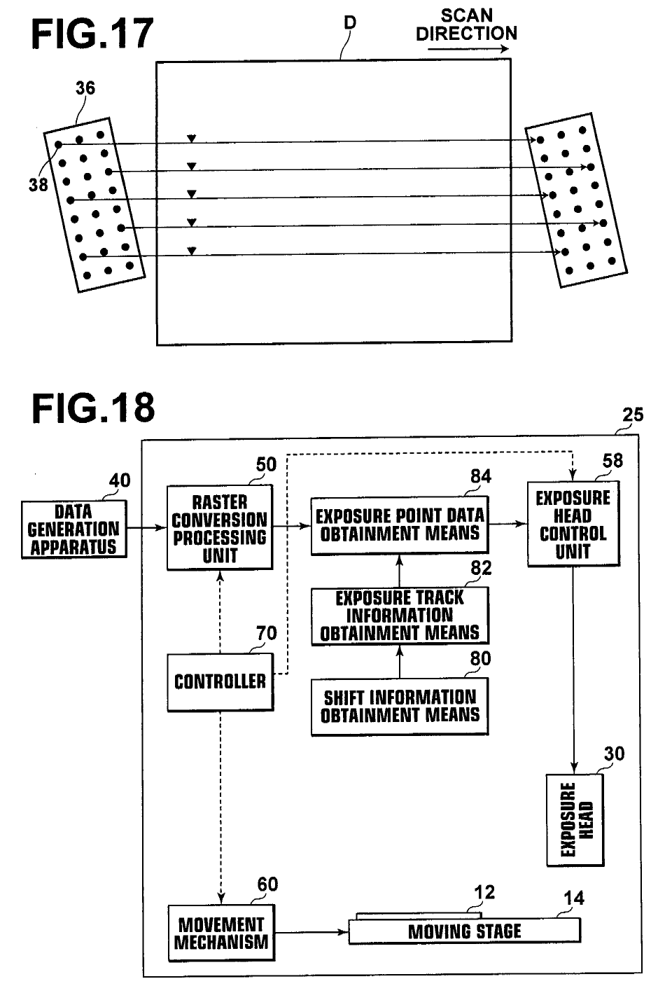

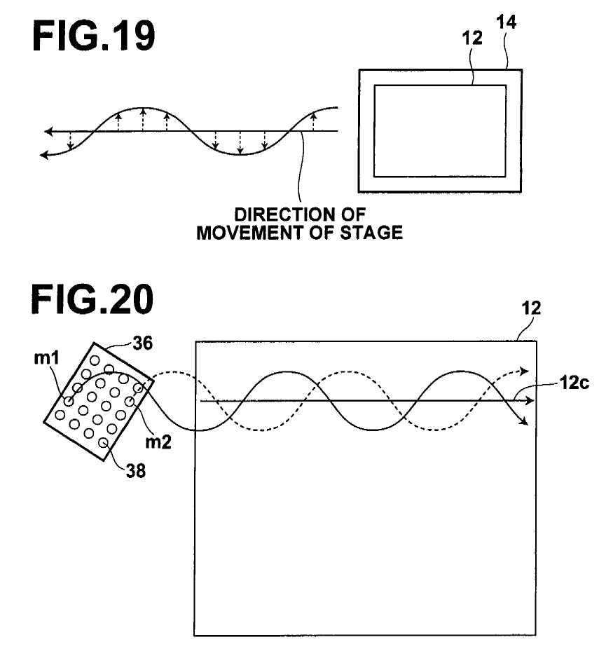

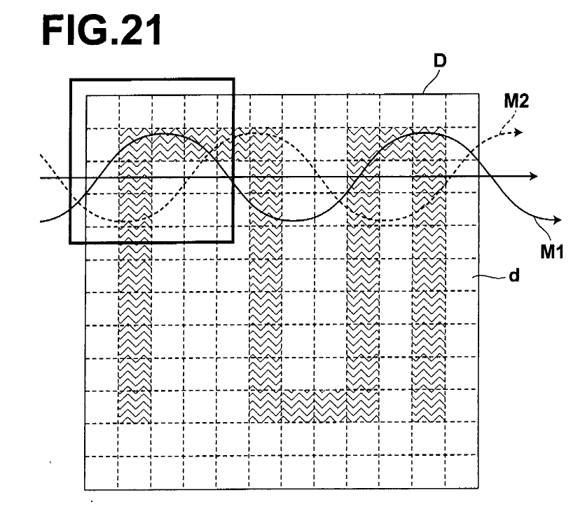

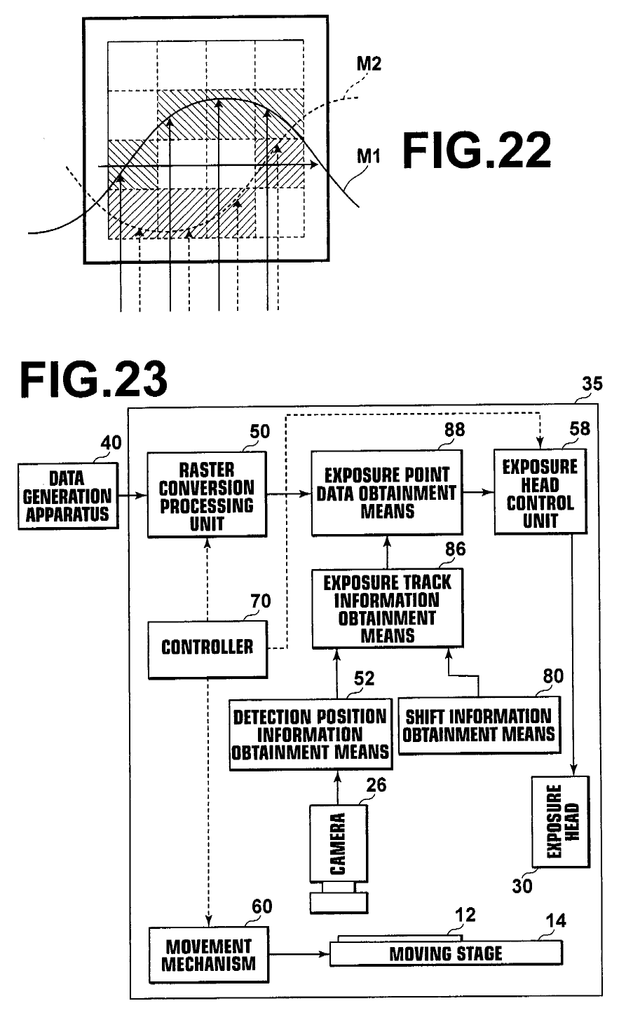

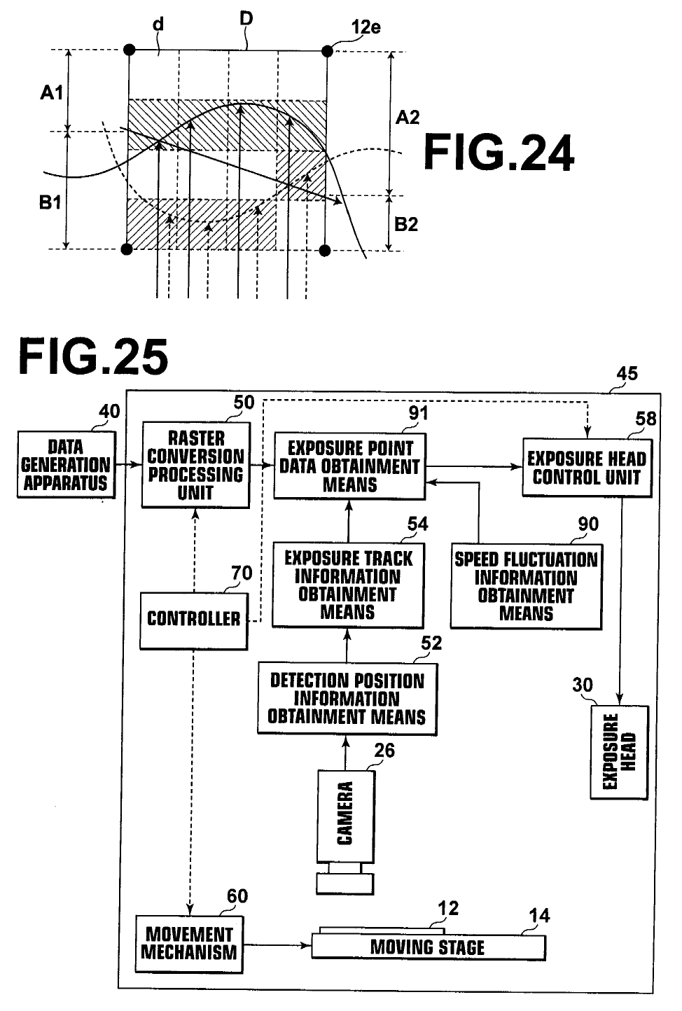

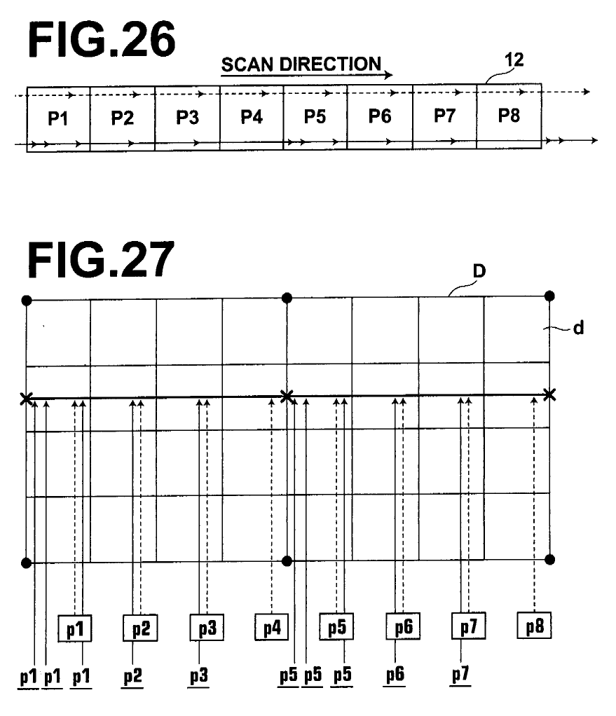

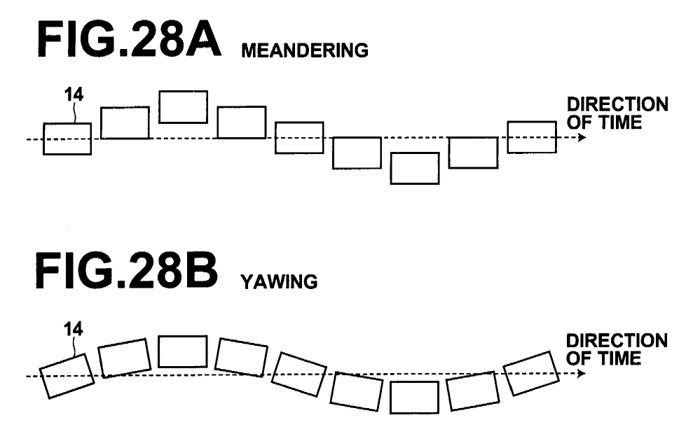

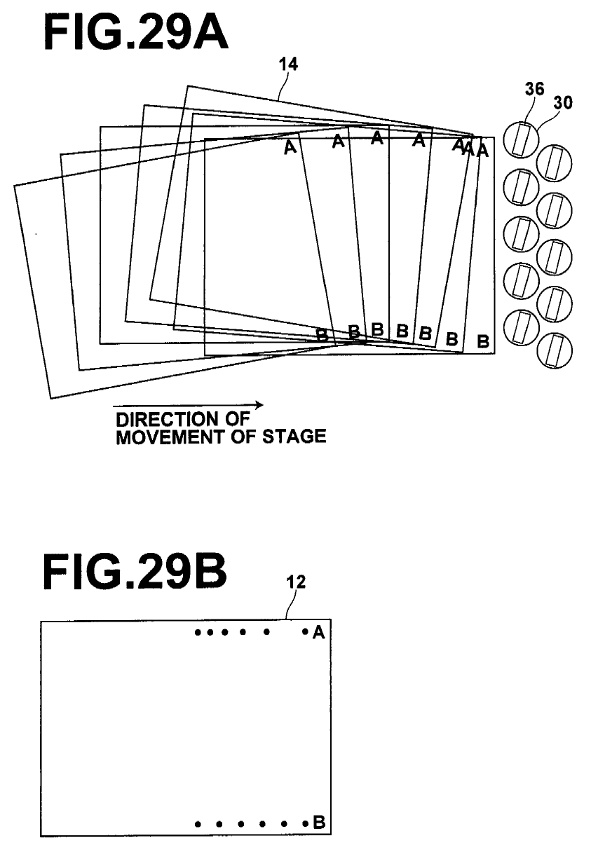

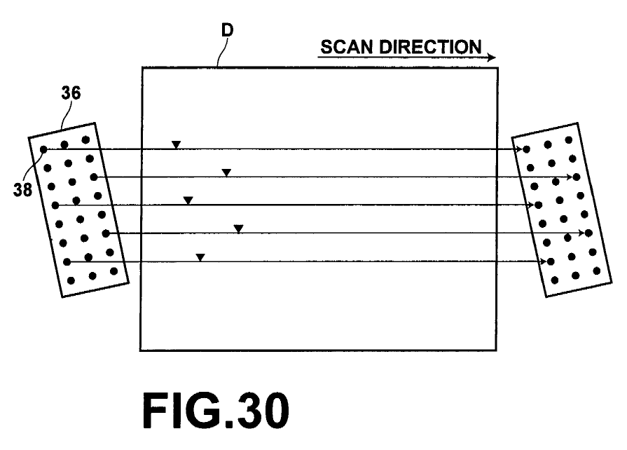

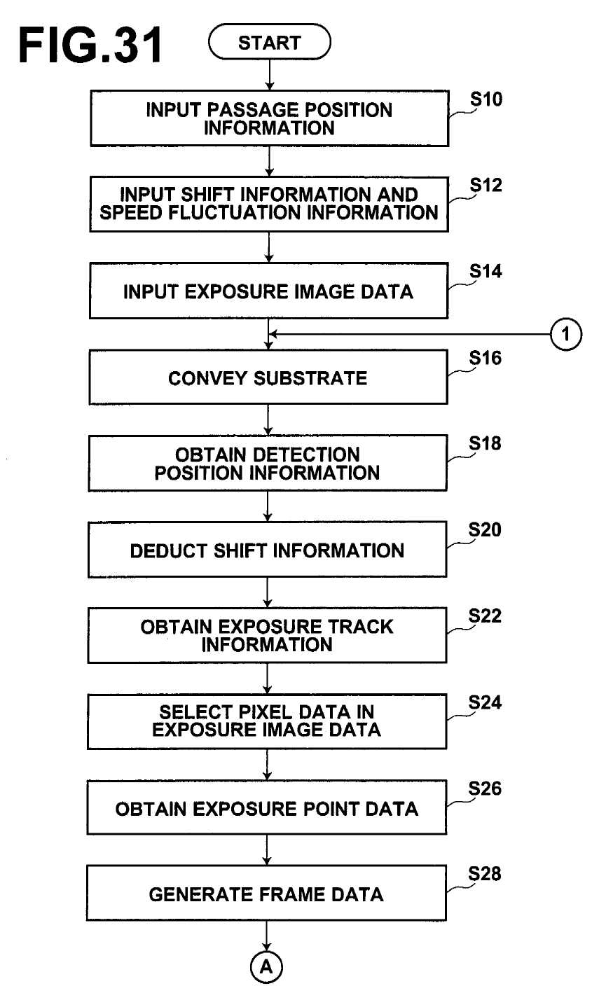

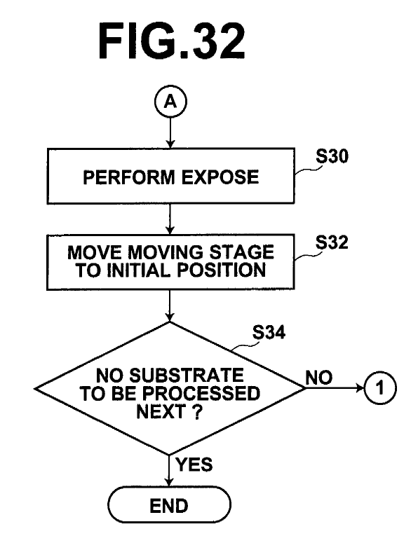

### BRIEF DESCRIPTION OF DRAWINGS

[FIG. 1] A schematic perspective view showing the configuration of an exposure apparatus using the first through fourth embodiments of drawing methods and apparatuses of the present invention

[FIG. 2] A perspective view showing the configuration of a scanner of the exposure apparatus illustrated in FIG. 1

[FIG. 3A] A plan view illustrating exposed areas formed on the exposure surface of a substrate

[FIG. 3B] A plan view illustrating the arrangement of exposure areas formed by exposure heads

[FIG. 4] A diagram illustrating a DMD in an exposure head of the exposure apparatus illustrated in FIG. 1

[FIG. 5] A block diagram illustrating the configuration of an electrical control system of an exposure apparatus using the first embodiment of the present invention

[FIG. 6] A schematic diagram illustrating the relationship between base marks on an ideally-shaped substrate and information about passage positions of a predetermined micromirror

[FIG. 7] A diagram for explaining a method for obtaining information about an exposure track of a micromirror

[FIG. 8] A diagram for explaining a method for obtaining information about an exposure track of a micromirror

[FIG. 9] A diagram for explaining a method for obtaining exposure point data based on information about an exposure track of a micromirror

[FIG. 10] A diagram illustrating a part within a bold frame in FIG. 9

[FIG. 11] A diagram for explaining a method for obtaining exposure point data based on information about an exposure track of a micromirror

[FIG. 12] A diagram illustrating an exposure point data string for each micromirror

[FIG. 13] A diagram illustrating each frame data

[FIG. 14A] A diagram illustrating a manner in which a substrate is placed at an inclined angle

[FIG. 14B] A diagram illustrating information about an exposure point data track based on the inclination of an edge of a substrate

[FIG. 15] A diagram for explaining expansion/shrinkage (contraction) of a substrate in a scan direction

[FIG. 16] A diagram for explaining a method for obtaining exposure point data based on expansion/shrinkage of a substrate

[FIG. 17] A diagram illustrating adjustment points in the information about the exposure point data track when exposure point data is adjusted based on expansion/shrinkage of a substrate

[FIG. 18] A block diagram illustrating the configuration of an electrical control system of an exposure apparatus using the second embodiment of the present invention

[FIG. 19] A diagram for explaining a shift in the direction of the movement of a moving stage

[FIG. 20] A diagram illustrating an exposure track of a predetermined micromirror

[FIG. 21] A diagram for explaining a method for obtaining exposure point data based on information about an exposure track of a micromirror

[FIG. 22] A diagram illustrating the part within a bold frame in FIG. 21

[FIG. 23] A block diagram illustrating the configuration of an electrical control system of an exposure apparatus using the third embodiment of the present invention

[FIG. 24] A diagram for explaining a method for obtaining information about an exposure track of a micromirror

[FIG. 25] A block diagram illustrating the configuration of an electrical control system of an exposure apparatus using the fourth embodiment of the present invention

[FIG. 26] A diagram illustrating an exposure track of a micromirror and the timing of exposure by the micromirror

[FIG. 27] A diagram for explaining a method for obtaining exposure point data based on speed fluctuation information about a moving stage

[FIG. 28A] A diagram for explaining meandering (snaking)

[FIG. 28B] A diagram for explaining yawing

[FIG. 29A] A diagram for explaining yawing

[FIG. 29B] A diagram illustrating exposure pointes when yawing has occurred

[FIG. 30] A diagram illustrating points in information about exposure point data tracks, the points at which readout pitches (sampling pitches) are changed during readout of exposure point data

[FIG. 31] A flow chart for explaining the action of an exposure apparatus that is structured by using all of the first through fourth embodiments of the present invention

[FIG. 32] A flow chart for explaining the action of an exposure apparatus that is structured by using all of the first through fourth embodiments of the present invention

### BEST MODE FOR CARRYING OUT THE INVENTION

Hereinafter, an exposure apparatus using the first embodiment of a drawing point data obtainment method and apparatus of the present invention and a drawing method and apparatus of the present invention will be described in detail with reference to the drawings. FIG. 1 is a schematic perspective view illustrating the configuration of an exposure apparatus using the first embodiment of the present invention. The exposure apparatus using the first embodiment of the present invention is an apparatus for exposing each layer of a multilayer printed circuit board to light in various patterns, such as a circuit pattern (wiring pattern). The characteristic feature of the exposure apparatus lies in its method for obtaining exposure data that is used to expose each layer to light of a pattern. First, the configuration of the exposure apparatus will be outlined.

As illustrated in FIG. 1, an exposure apparatus 10 includes a flat-plate-shaped moving stage 14, which holds a substrate 12 on the surface thereof by suction. Further, a thick-plate-shaped base 18 is supported by four legs 16, and two guides 20 are set on the upper surface of the base 18. The two guides 20 extend along the direction of the movement of the stage. The moving stage 14 is placed in such a manner that the longitudinal direction of the moving stage 14 is directed along the direction of the movement thereof. Further, the moving stage 14 is supported by the guides 20 in such a manner that the moving stage 14 can move back and forth.

Further, a Japanese-KO-shaped gate (C-shaped gate) 22 is provided at a central part of the base 18 in such a manner that the Japanese-KO-shaped gate straddles the moving path of the moving stage 14. Each end of the Japanese-KO-shaped gate 22 is fixed onto either side of the base 18. Further, a scanner 24 is provided on one side of the gate 22, and a plurality of cameras 26 are provided on the other side of the gate 22. The plurality of cameras 26 detect the leading edge and the rear edge of the substrate 12 and the positions of a plurality of circular base marks 12a, which are provided in advance on the substrate 12.

The base marks 12a on the substrate 12 are, for example, holes that are formed on the substrate 12 based on base mark position information, which has been set in advance. As the base marks 12a, lands, vias (via holes) and etching marks may be used instead of the holes. Alternatively, a predetermined pattern formed on the substrate 12, for example, such as a pattern formed on a layer below a layer to be exposed to light, may be used as the base marks 12a. In FIG. 1, only six base marks 12a are illustrated. However, in actual cases, a multiplicity of base marks 12a are provided.

Each of the scanner 24 and the cameras 26 is attached to the gate 22 and placed at a fixed position above the movement path of the moving stage 14. Further, the scanner 24 and the cameras 26 are connected to a controller for controlling them. The controller will be described later.

As illustrated in FIG. 2 and FIG. 3B, the scanner 24 includes ten exposure heads 30 (30A through 30J), which are arranged substantially in matrix form of 2 rows×5 columns.

Further, a digital micromirror device (DMD) 36 is provided in each of the exposure heads 30, as illustrated in FIG. 4. The digital micromirror device 36 is a spatial light modulation device (SLM) for performing spatial modulation on a light beam that has entered the exposure head 30. In the DMD 36, a multiplicity of micromirrors 38 are two-dimensionally arranged in orthogonal directions. The DMD 36 is attached to the exposure head 30 in such a manner that the column direction of the micromirrors 38 forms a predetermined set inclination angle θ with respect to the scan direction. Therefore, an exposure area 32 formed by each of the exposure heads 30 is a rectangular area that is inclined with respect to the scan direction. As the stage 14 moves, a band-shaped exposed area 34 is formed on the substrate 12 by each of the exposure heads 30. In FIG. 4, a light source that emits a light beam to each of the exposure heads 30 is not illustrated. As the light source, a laser light source or the like can be used.

ON/OFF of each of the micromirrors 38 of the DMD 36, which is provided in each of the exposure heads 30, is controlled independently from each other. Consequently, dot patterns (black/white) corresponding to images (beam spots) of the micromirrors 38 of the DMD 36 are formed on the substrate 12. The aforementioned band-shaped exposed areas 34 are formed by two-dimensionally-arranged dots corresponding to the micromirrors 38 illustrated in FIG. 4. Since the two-dimensionally-arranged dot patterns are inclined with respect to the scan direction, a dot that is adjacent, in the scan direction, to dots that are adjacent to each other in a direction intersecting the scan direction passes between the dots. Therefore, high resolution exposure becomes possible. Further, there are cases in which some of the dots are not utilized depending on the variation in adjustment of the inclination angles. For example, in FIG. 4, shaded dots are not utilized, and micromirrors 38 in the DMD 36 corresponding to these dots are constantly set to OFF state.

Further, as illustrated in FIGS. 3A and 3B, the linearly-arranged exposure heads 30 in each row are arranged in such a manner that they are shifted from those in the other row by a predetermined distance in the arrangement direction of the exposure heads in each row. The exposure heads are arranged in such a manner so that each of the band-shaped exposed areas 34 partially overlaps with an adjacent band-shaped exposed area 34. Therefore, for example, an area between an exposed area 32A, which is the leftmost exposed area in the first row, and an exposed area 32C, which is positioned to the immediate right of the exposed area 32A, is exposed to light by an exposed area 32B, which is the leftmost exposed area in the second row. Similarly, an area between an exposed area 32B and an exposed area 32D, which is positioned to the immediate right of the exposed area 32B, is exposed to light by an exposed area 32C.

Next, the electrical configuration of the exposure apparatus 10 will be described. As illustrated in FIG. 5, the exposure apparatus 10 includes a raster conversion processing unit 50, a detection position information obtainment means 52, an exposure track information obtainment means 54, an exposure point data obtainment means 56, an exposure head control unit 58, a movement mechanism 60 and a controller 70. The raster conversion processing unit 50 receives vector data representing a circuit pattern (wiring patterns) to be formed by exposure, the vector data being output from a data generation apparatus 40 including a CAM (Computer Aided Manufacturing) station. Then, the raster conversion processing unit 50 converts the vector data into raster data (bitmap data). The detection position information obtainment means 52 obtains information (detection position information) about the detection positions of the base marks 12a based on images of the base marks 12a obtained by photography with the cameras 26. The exposure track information obtainment means 54 obtains, based on the detection position information obtained by the detection position information obtainment means 52, information about the actual exposure track of each of the micromirrors 38 in an image space on the substrate 12. The exposure point data obtainment means 56 obtains exposure point data for each of the micromirrors 38. The exposure point data obtainment means 56 obtains the data based on the information about the exposure track of each of the micromirrors 38, obtained by the exposure track information obtainment means 54, and exposure image data of the raster data output from the raster conversion processing unit 50. The exposure head control unit 58 controls the exposure heads 30 in such a manner that exposure is performed by the DMD 36 of each of the exposure heads 30 based on exposure point data for each of the micromirrors 38 obtained by the exposure point data obtainment means 56. The movement mechanism 60 moves the moving stage 14 in the direction of the movement of the stage. The controller 70 controls the whole exposure apparatus of the present invention. Further, the movement mechanism 60 may have any known structure as long as the movement mechanism 60 can move the moving stage 14 back and forth along the guides 20. The action of each of the aforementioned elements will be described later in detail.

Next, the action of the exposure apparatus 10 using the first embodiment of the present invention will be described with reference to the drawings.

First, in the data generation apparatus 40, vector data representing a circuit pattern to be formed on the substrate 12 by exposure is generated. Then, the vector data is input to the raster conversion processing unit 50, and the vector data is converted into raster data in the raster conversion processing unit 50. The raster data is output from the raster conversion processing unit 50 to the exposure point data obtainment means 56 and temporarily stored in the exposure point data obtainment means 56.

Meanwhile, when the vector data is input to the raster conversion processing unit 50, as described above, the controller 70, which controls the operation of the whole exposure apparatus 10, outputs a control signal to the movement mechanism 60. Then, the movement mechanism 60 moves the moving stage 14 based on the control signal. The moving stage 14 is once moved, along the guides 20, from the position illustrated in FIG. 1 to a predetermined initial position on the upstream side. After the moving stage 14 is moved to the initial position, the moving stage 14 is moved toward the downstream side at a desirable speed. The upstream side is the right side in FIG. 1, which is the scanner 24 side of the gate 22. The downstream side is the left side in FIG. 1, which is the cameras 26 side of the gate 22.

When the substrate 12 on the moving stage 14, which moves as described above, passes under the plurality of cameras 26, the substrate 12 is photographed with the cameras 26. Then, photography image data representing the photographed images is input to the detection position information obtainment means 52. The detection position information obtainment means 52 obtains, based on the input photography image data, detection position information indicating the positions of the base marks 12a on the substrate 12. As the method for obtaining the detection position information about the base marks 12a, there is a method for obtaining the detection position information by extracting circular images, for example. However, any known obtainment methods may be adopted. Specifically, the detection position information about the base marks 12a is obtained as coordinate values, and the origin of the coordinate values may be one of the corners of the photography image data of the substrate 12, for example. Alternatively, the origin of the coordinate values may be a predetermined position of the photography image data, the predetermined position being set in advance, or the origin may be the position of one of the plurality of base marks 12a. As described above, in the embodiment of the present invention, the position information detection means is formed by the cameras 26 and the detection position information obtainment means 52.

The detection position information about the base marks 12a, obtained as described above, is output from the detection position information obtainment means 52 to the exposure track information obtainment means 54.

Then, the exposure track information obtainment means 54 obtains information about the actual exposure track of each of the micromirrors 38 in the image space on the substrate. The exposure track information obtainment means 54 obtains the information based on the input detection position information. Specifically, information (passage position information) about the passage position of each of the micromirrors 38 is set in advance in the exposure track information obtainment means 54. The information about the passage position of each of the micromirrors 38 indicates positions through which the image of each of the micromirrors 38 of the DMD 36 in each of the exposure heads 30 passes. The passage position information is set in advance based on the setting position of each of the exposure heads 30 with respect to the setting position of the substrate 12 on the moving stage 14. The passage position information is represented by a vector or a plurality of coordinate values, and the point used, as the origin, in the base mark position information and the detection position information is also used as the origin in the passage position information. FIG. 6 is a schematic diagram illustrating the relationship between a substrate 12 and a passage position information set 12c about a predetermined micromirror 38. The substrate 12 illustrated in FIG. 6 is an ideally-shaped substrate 12, on which a press process or the like has not been carried out. In other words, the substrate 12 is not deformed (such as warping), and the base marks 12a are positioned at positions indicated by base mark position information sets 12b, which have been set in advance.

Further, as illustrated in FIG. 7, the exposure track information obtainment means 54 can obtain the coordinate values of intersections of straight lines connecting detection position information sets 12d adjacent to each other in a direction perpendicular to the scan direction and a straight line indicating the passage position information set 12c about each of the micromirrors 38. Specifically, the coordinate values of points indicated with × in FIG. 7 are obtained. Further, a distance between the mark × and each of the detection position information sets 12d adjacent to the mark × in the direction perpendicular to the scan direction is obtained. Then, a ratio of a distance between the mark × and one of the detection position information sets 12d adjacent to the mark × to a distance between the mark × and the other detection position information set 12d adjacent to the mark × is obtained. Specifically, the ratios a1:b1, a2:b2, a3:b3 and a4:b4 in FIG. 7 are obtained as the information about the exposure track. The ratios obtained as described above indicate the exposure track of a micromirror 38 on a deformed substrate 12. If each of base mark position information sets 12b is viewed as information indicating the position of a pattern formed on a lower layer, the obtained exposure track should indicate an actual exposure track of a beam in an image space on the substrate 12. For example, even if the passage position information set 12c is positioned on the outside of the range (area) surrounded by detection position information sets 12d, as illustrated in FIG. 8, ratios can be obtained. The ratio of a distance between a detection position information set 12d and a mark × to a distance between a detection position information set 12d and the mark × is obtained as illustrated in FIG. 8.

Then, the information about the exposure track, obtained for each of the micromirrors 38 as described above, is input to the exposure point data obtainment means 56.

In the exposure point data obtainment means 56, exposure image data D, which is raster data, has temporarily been stored as described above. The exposure point data obtainment means 56 obtains, based on the information about the exposure track that has been input as described above, exposure point data for each of the micromirrors 38 from the exposure image data D.

Specifically, as illustrated in FIG. 9, the exposure image data D stored in the exposure point data obtainment means 56 includes exposure image data base position information sets 12e positioned at positions corresponding to the positions indicated by the base mark position information sets 12b. In FIG. 9, the coordinate values of points dividing, at the ratios indicated by the information about the exposure track, straight lines connecting exposure image data base position information sets 12e adjacent to each other in a direction perpendicular to the scan direction are obtained. Specifically, the coordinate values of points satisfying the following equations are obtained. In FIG. 9, the hatched portion indicates an example of a circuit pattern that should be formed by exposure.

a1:b1=A1:B1

a2:b2=A2:B2

a3:b3=A3:B3

a4:b4=A4:B4

Further, pixel data d that is present on a line (data readout track or data track) connecting the points obtained as described above is exposure point data actually corresponding to the information about the exposure track of the micromirror 38. Therefore, pixel data d on a point through which the straight line passes in the exposure image data D is obtained as exposure point data. The pixel data d is minimum-unit data that forms the exposure image data D. FIG. 10 is a diagram illustrating a part within a bold line in FIG. 9. Specifically, pixel data in the hatched portion of FIG. 10 is obtained as exposure point image data. If a straight line connecting points obtained by diving lines based on the ratios indicated by the information about the exposure track is not present in the exposure image data D, 0 is obtained as exposure point data on the straight line.

As described above, points dividing lines based on the ratios indicated by the information about the exposure track may be connected by a straight line, and pixel data present on the straight line may be obtained as exposure point data. Alternatively, as illustrated in FIG. 11, the aforementioned points may be connected by a curved line by performing spline interpolation or the like. Then, pixel data present on the curved line may be obtained as exposure point data. If the points are connected by the curved line by spline interpolation or the like, as described above, it is possible to obtain exposure point data that can more faithfully represent the deformation of the substrate 12. Further, if the operation method, such as the spline interpolation, is carried out in a manner that is appropriate for the properties (such as a characteristic that the material expands or shrinks only in a specific direction) of the material of the substrate 12, it is possible to obtain exposure point data that can even more faithfully represent the deformation of the substrate 12.

Then, a plurality of exposure point data sets are obtained for each of the micromirrors 38 in a manner similar to the aforementioned process. Further, the exposure point data sets for each of the micromirrors 38 are output to the exposure head control unit 58.

The exposure point data sets for each of the micromirrors 38 are output to the exposure head control unit 58, as described above, and the moving stage 14 is moved again toward the upstream side at a desirable speed.

Then, when the cameras 26 detect the leading edge of the substrate 12 (or when the position of a drawing area on the substrate 12 is identified based on the position of the stage detected by the sensor), exposure starts. Specifically, a control signal based on the exposure point data sets is output from the exposure head control unit 58 to the DMD 36 in each of the exposure heads 30. In the exposure head 30, the micromirrors of the DMD 36 are turned ON/OFF based on the input control signal.

When control signals are output from the exposure head control unit 58 to each of the exposure heads 30, a control signal corresponding to each position of each of the exposure heads 30 with respect to the substrate 12 is sequentially output from the exposure head control unit 58 to each of the exposure heads 30 as the moving stage 14 moves. At this time, for example as illustrated in FIG. 12, exposure point data sets corresponding to the positions of each of the exposure heads 30 may be sequentially read out one by one from each string of m exposure point data sets obtained for each of the micromirrors 38. Then, the readout data may be output to the DMD 36 in each of the exposure heads 30. Alternatively, 90-degree rotation processing or transposition transformation using a matrix may be performed on the exposure point data obtained as illustrated in FIG. 12, and frame data sets 1 through m corresponding to each position of each of the exposure heads 30 with respect to the substrate 12 may be generated, as illustrated in FIG. 13. Then, the frame data sets 1 through m may be sequentially output to each of the exposure heads 30.

Then, as the moving stage 14 moves, control signals are sequentially output to each of the exposure heads 30 and exposure is performed. Further, when the rear edge of the substrate 12 is detected by the camera 26, exposure ends.

According to the exposure apparatus 10 using the first embodiment of the present invention, a plurality of base marks 12a provided at predetermined positions on the substrate 12 are detected and detection position information indicating the positions of the base marks 12a is obtained. Then, information about the exposure track of each of the micromirrors 38 is obtained based on the obtained detection position information, and pixel data d corresponding to the information about the exposure track of each of the micromirrors 38 is obtained, as exposure point data, from the exposure image data D. Therefore, it is possible to obtain exposure point data based on the deformation of the substrate 12. Further, it is possible to form an exposure image based on the deformation of the substrate 12 on the substrate 12. Therefore, for example, when a pattern is formed on each layer of a multilayer printed circuit board or the like, it is possible to form the pattern based on the deformation of each layer, the deformation being present at the time of exposure. Hence, it is possible to correctly position the pattern of each layer.

In the above description, the method for obtaining exposure point data that is used when exposure is performed on the substrate 12 that was deformed in a press process or the like has been explained. However, a method similar to the aforementioned method may be used to obtain exposure point data when exposure is performed on an ideally-shaped substrate 12, which is not deformed. For example, information about an exposure point data track in the exposure image data, the information corresponding to the passage position information that has been set in advance for each of the micromirrors 38, may be obtained. Then, a plurality of exposure point data sets corresponding to the exposure point data track may be obtained, based on the obtained information about the exposure point data track, from the exposure image data.

Further, the method, in which information about an exposure point data track is set in advance, based on the passage position information about each of the micromirrors 38, in the exposure image data and exposure point data is obtained based on the exposure point data track, as described above, may be adopted, for example, when an exposure image is formed for the first time on a substrate on which no exposure image has been formed. Alternatively, this method may be adopted when exposure image data has been transformed based on the deformation of the substrate. If this method is adopted, it is possible to obtain exposure point data by calculating the addresses of a memory, at which the exposure image data is stored, along the exposure point data track. Hence, it is possible to easily calculate the addresses.

Further, when the substrate 12 placed on the stage 14 is inclined as illustrated in FIG. 14A, an edge of the substrate 12 may be detected by the cameras 26, and the inclination of the edge with respect to the passage position information sets 12c of the micromirrors 38 may be obtained. Then, as illustrated in FIG. 14B, information about exposure point data tracks (the arrows in FIG. 14B) may be set, based on the obtained inclination, in the exposure image data, and exposure point data in the information about the exposure point data tracks may be obtained.

Further, for example as illustrated in FIG. 15, if the substrate 12 has expanded or shrunk in the scan direction, the number of exposure point data sets obtained from a single pixel data set d in the exposure image data D may be changed based on the degree of expansion/shrinkage. Specifically, for example, if the substrate 12 expands or shrinks in the scan direction, as described above, the relationship between the detection position information set 12d and the passage position information set 12c is as illustrated in FIG. 15. In the relationship illustrated in FIG. 15, areas A, B and C are present. The area A is an area in which the distance between the detection position information sets 12d that are adjacent to each other in the scan direction is an ideal length L. The area B is an area in which the substrate 12 has expanded in the scan direction, and in which the aforementioned distance has become twice the length L. The area C is an area in which the substrate 12 has shrunk in the scan direction, and in which the aforementioned distance has become half the length L. If the substrate 12 is deformed in such a manner, exposure point data may be obtained, for example, as illustrated in FIG. 16. Specifically, with respect to exposure point data corresponding to the area A, a single exposure point data set may be obtained from a single pixel data set d. With respect to exposure point data corresponding to the area B, two exposure point data sets may be obtained from a single pixel data set d. With respect to exposure point data corresponding to the area C, a single exposure point data set may be obtained from two pixel data sets. In FIG. 16, the arrows in dotted lines indicate the number of exposure point data sets obtained for each area and pixel data sets d corresponding to the exposure point data sets. Further, when a single exposure point data set is obtained from two pixel data sets, one of the two pixel data sets should be selected as the exposure point data set. In the above explanation, the method for obtaining exposure point data when the substrate 12 has expanded or shrunk only in the scan direction has been described. However, it is not necessary that the substrate 12 is deformed in such a manner. When the substrate 12 is deformed in another direction besides the scan direction, if the length of the passage position information of the micromirror 38 is different from each other in each of the areas divided by the detection position information 12d on the substrate 12, the number of exposure point data sets obtained from a single pixel data set may be changed based on the length of the passage position information in a manner similar to the aforementioned method. If the number of exposure point data sets is changed based on the expansion/shrinkage of the substrate 12, as described above, it is possible to form a desirable exposure image at a desirable position on the substrate 12.

When the number of exposure point data sets to be obtained is adjusted based on the expansion/shrinkage of the substrate 12, as described above, it is desirable that the number of the exposure point data sets is adjusted at the same position (the black triangles in FIG. 17) of the information about the exposure point data track (the arrows in FIG. 17) about each of the micromirrors 38 with respect to the scan direction in the image space of the exposure image data D, as illustrated in FIG. 17.

Next, an exposure apparatus 25 using a second embodiment of the drawing point data obtainment method and apparatus of the present invention and the drawing method and apparatus of the present invention will be described in detail. The schematic external configuration of the exposure apparatus 25 is similar to that of the exposure apparatus 10 using the first embodiment of the present invention, illustrated in FIG. 1.

As illustrated in FIG. 18, the exposure apparatus 25 includes a raster conversion processing unit 50, a shift information obtainment means 80, an exposure track information obtainment means 82, an exposure point data obtainment means 84, an exposure head control unit 58, a movement mechanism 60 and a controller 70. The shift information obtainment means 80 obtains information about the shift of the moving stage 14 in a direction perpendicular to the direction of the movement of the stage. The exposure track information obtainment means 82 obtains information about the actual exposure track of each of the micromirrors 38 on the substrate 12. The exposure point data obtainment means 84 obtains exposure point data for each of the micromirrors 38 based on the information about the exposure track of each of the micromirrors 38, obtained by the exposure track information obtainment means 82, and exposure image data of raster data that has been output from the raster conversion processing unit 50. The controller 70 controls the whole exposure apparatus of the present invention. In FIG. 18, the actions of the elements to which the same reference numerals as those used in FIG. 5 are assigned are similar to the actions of the elements in the exposure apparatus 10 using the first embodiment of the present invention.

Next, the action of the exposure apparatus 25 will be described with reference to diagrams.

First, the action till temporarily storing the raster data in the exposure point data obtainment means 84 is similar to the action of the exposure apparatus 10 using the first embodiment of the present invention.

Next, the shift information obtainment means 80 obtains the information about the shift of the moving stage 14. The information about the shift indicates the shift in the direction of the actual movement of the moving stage 14 with respect to the direction of the movement of a stage, the direction having been set in advance, as illustrated in FIG. 19. Specifically, as illustrated in FIG. 19, the information about the shift (shift information) is information about the shift amounts of the actual movement path of the moving stage 14, the shift amounts being shift amounts in a direction perpendicular to the direction of the movement of the stage, with respect to the movement path of the moving stage 14 in the direction of the movement of the stage, the movement path having been set in advance. The shift amounts of the actual movement path of the moving stage 14 are obtained at predetermined intervals. In FIG. 19, the direction and the length of each of the arrows in dotted lines represent a shift amount.

If the movement path of the moving stage 14 is shifted, as described above, the actual exposure track of each of the micromirrors 38 on the substrate 12 is shifted, as illustrated in FIG. 20. The actual exposure track is shifted, by amounts based on the aforementioned shift amounts, with respect to the passage position information set 12c about each of the micromirrors 38 that has been set in advance. Therefore, it is necessary to obtain exposure point data corresponding to the actual exposure track of each of the micromirrors 38. Further, as illustrated in FIG. 20, micromirror m1 and micromirror m2 should pass through the same positions on the substrate 12. However, if the movement path of the moving stage 14 is shifted as described above, the phase of the actual exposure track of micromirror m1 and that of micromirror m2 are shifted from each other. Therefore, it is necessary to consider these phase shifts when the exposure point data is obtained.

Therefore, in the exposure apparatus 25, exposure point data based on the shift amount of the exposure track of each of the micromirrors 38, as described above, is obtained. Specifically, a shift amount of the moving stage 14 is measured in advance, and the measured shift amount is obtained by the shift amount obtainment means 80, as described above. Then, the shift amount obtainment means 80 outputs the obtained shift amount to the exposure track information obtainment means 82. As a method for measuring the shift amount, a measurement method using laser light that is used in an IC wafer stepper apparatus or the like may be adopted for example. For example, a reflective surface extending in the direction of the movement of the stage is provided on the moving stage 14, and a laser light source for emitting laser light toward the reflective surface and a detection unit for detecting reflection light reflected from the reflective surface are provided. Then, a phase shift of the reflection light is sequentially detected by the detection unit as the moving stage 14 moves. Accordingly, it is possible to measure the shift amount.

In the exposure track information obtainment means 82, a passage position information set 12c about each of the micromirrors 38 has been set. The exposure track information obtainment means 82 obtains information about an exposure track, the information indicating an actual exposure track on the substrate 12, for each of the micromirrors 38. The exposure track information obtainment means 82 obtains the exposure track information based on the input shift amount and the passage position information 12c about each of the micromirrors 38. The passage position information 12c is similar to the passage position information explained above for the exposure apparatus 10 using the first embodiment.

Then, exposure track information about each of the micromirrors 38 is output to the exposure point data obtainment means 84. The exposure point data obtainment means 84 obtains exposure point data corresponding to the exposure track information about each of the micromirrors 38 from the temporarily-stored exposure image data D.

Specifically, in the exposure image data D illustrated in FIG. 21, exposure point data d positioned on the exposure track information M1 and M2, indicated with curved lines, is obtained. FIG. 22 illustrates a part within a bold frame in FIG. 21. Specifically, pixel data in the hatched portion of FIG. 22 is obtained as exposure point data. The exposure track information M1, illustrated in FIG. 21, is information about the exposure track of micromirror m1, illustrated in FIG. 20. The exposure track information M2, illustrated in FIG. 21, is information about the exposure track of micromirror m2, illustrated in FIG. 20. Further, the exposure image data D has a relative positional relationship with the passage position information 12c. It is assumed that the origin that is a basis of the arrangement of each pixel data set d of the exposure image data D and the origin of the passage position information 12c are the same.

Then, a plurality of exposure point data sets are obtained for each of the micromirrors 38 in a manner similar to the aforementioned process, and exposure point data for each of the micromirrors 38 is output to the exposure head control unit 58.

While the exposure point data for each of the micromirrors 38 is output to the exposure head control unit 58, as described above, the moving stage 14 is moved toward the upstream side at a desirable speed.

Then, when the leading edge of the substrate 12 is detected by the camera 26, exposure starts. Specifically, the exposure head control unit 58 outputs a control signal based on the exposure point data to the DMD 36 of each of the exposure heads 30. The exposure head 30 turns ON/OFF the micromirrors of the DMD 36 based on the input control signal and exposes the substrate 12 to light.

In the exposure apparatus 25 using the second embodiment of the present invention, information about the shift in the direction of the actual relative movement of the substrate 12 with respect to a predetermined direction of the relative movement of the substrate 12 that has been set in advance is obtained, the shift being present when exposure for forming an exposure image is performed. Then, exposure track information is obtained based on the obtained information about the shift. Accordingly, exposure point data corresponding to the exposure track information can be obtained from the exposure image data D. Therefore, it is possible to form a desirable exposure image at a desirable position on the substrate 12 without being affected by the shift in the direction of the movement of the substrate 12.

Next, an exposure apparatus 35 using a third embodiment of the exposure point data obtainment method and apparatus of the present invention and the drawing method and apparatus of the present invention will be described in detail.

As illustrated in FIG. 23, in the exposure apparatus 35, the configuration of the exposure apparatus 10, using the first embodiment of the present invention, and the configuration of the exposure apparatus 25, using the second embodiment of the present invention, are combined with each other.

In the exposure apparatus 35, the detection position information about the base marks 12a, which has been obtained by the detection position information obtainment means 52 as described above, and the shift information, which has been obtained by the shift information obtainment means 80 as described above, are input to the exposure track information obtainment means 86.

Then, the exposure track information obtainment means 86 obtains, based on the input detection position information and the shift information, exposure track information indicating an actual exposure track in the image space on the substrate 12 for each of the micromirrors 38.

Specifically, the exposure track information obtainment means 86 obtains the coordinate value of an intersection of a straight line connecting detection position information sets 12d that are adjacent to each other in a direction perpendicular to the scan direction and a straight line indicating the passage position information 12c about each of the micromirrors 38 in a manner similar to the process in the first embodiment. Then, a length between the intersection and each of detection position information sets 12d that are adjacent to each other in the perpendicular direction is obtained. Then, a ratio of a distance between the intersection and one of the adjacent detection position sets 12d to a distance between the intersection and the other detection position set 12d is obtained.

Meanwhile, the exposure track information obtainment means 86 obtains provisional exposure track information on the substrate 12 for each of the micromirrors 38, as indicated with a curved line in FIG. 21, in a manner similar to the process in the second embodiment. The exposure track information obtainment means 86 obtains the provisional exposure track information based on the input shift amount and the passage position information 12c about each of the micromirrors 38.

Then, the exposure track information obtainment means 86 outputs the ratio obtained as described above and the provisional exposure track information, as exposure track information, to the exposure point data obtainment means 88.

Then, as illustrated in FIG. 24, the exposure point data obtainment means 56 obtains points dividing, based on the input ratio, straight lines connecting exposure image data base position information sets 12e that are adjacent to each other in a direction perpendicular to the scan direction in the exposure image data D in a manner similar to the process in the first embodiment. After obtaining the points, a straight line connecting the points is obtained. Then, a curved line indicating exposure track information is obtained by inclining the provisional exposure track information by an inclination angle of the straight line connecting the dividing points with respect to the scan direction, and pixel data d on the curved line is obtained as exposure point data. Specifically, pixel data in the hatched portion of FIG. 24 is obtained as the exposure point data. In FIG. 24, ratios A1:B1 and A2:B2 satisfy a1:b1=A1:B1 and a2:b2=A2:B2 when the ratios input from the exposure track information obtainment means 86 are a1:b1 and a2:b2.

Then, a curved line indicating the exposure track information about each of the micromirrors 38 is obtained in a manner similar to the aforementioned manner. Accordingly, pixel data d on each curved line is obtained as exposure point data for each of the micromirrors 38.

Then, the exposure point data for each of the micromirrors 38, which has been obtained as described above, is output to the exposure head control unit 58.

While the exposure point data for each of the micromirrors 38 is output to the exposure head control unit 58, as described above, the moving stage 14 is moved toward the upstream side at a desirable speed.

Then, when the leading edge of the substrate 12 is detected by the camera 26, exposure starts. Specifically, the exposure head control unit 58 outputs a control signal based on the exposure point data to the DMD 36 of each of the exposure heads 30. The exposure head 30 turns ON/OFF the micromirrors of the DMD 36 based on the input control signal. Accordingly, exposure is performed on the substrate 12.

Next, an exposure apparatus 45 using a fourth embodiment of the exposure point data obtainment method and apparatus of the present invention and the drawing method and apparatus of the present invention will be described in detail. The schematic external view of the configuration of the exposure apparatus 45 is similar to that of the exposure apparatus 10 using the first embodiment of the present invention, illustrated in FIG. 1.

As illustrated in FIG. 25, in addition to the components of the exposure apparatus 10 using the first embodiment of the present invention, the exposure apparatus 45 includes a speed fluctuation information obtainment means 90 for obtaining, in advance, speed fluctuation information about the movement of the substrate 12. Then, an exposure point data obtainment means 91 obtains, based on the speed fluctuation information obtained by the speed fluctuation information obtainment means 90, exposure point data from each of pixel data sets. The exposure point data obtainment means 91 obtains the exposure point data in such a manner that the number of exposure point data sets obtained from each of the pixel data sets increases as the speed of the movement of the moving stage 14 is slower. In FIG. 25, the actions of the elements to which the same reference numerals as those used in FIG. 5 have been assigned are the same as the actions of the components in the exposure apparatus 10 using the first embodiment.

Further, the speed fluctuation information about the movement of the substrate 12 is information indicating unevenness (irregularity or fluctuation) in the movement speed. The movement speed becomes irregular depending on the control accuracy of the movement mechanism 60 of the moving stage 14.

FIG. 26 is a diagram illustrating an exposure track of a predetermined micromirror 38 on the substrate 12 in actual exposure and the timing of exposure for forming an exposure point by the micromirror 38. In FIG. 26, the arrows in dotted lines indicate the exposure track of the micromirror 38 and exposure timing when the speed of the moving stage does not fluctuates. In FIG. 26, the arrows in solid lines indicate the exposure track of the micromirror 38 and exposure timing when the speed of the moving stage fluctuates. Further, in each of the straight lines, each arrow indicates exposure timing of each exposure point by the micromirror 38. In FIG. 26, for the purpose of explanation, two exposure tracks are indicated by two separate straight lines. However, these exposure tracks are exposure tracks of the same micromirror. Further, P1 through P8 in FIG. 26 indicate pixels forming an image that is formed on the substrate 12 by exposure. Further, the relative relationship between the exposure timing and the moving stage 14 is set in advance so that an exposure image having a desirable resolution is formed on the substrate 12.

As illustrated in FIG. 26, if the speed of the moving stage does not fluctuate, each of pixels P1 through P8 is formed by a single exposure point by the micromirror 38. In other words, the number of exposure points formed by the micromirror 38 is one for a single pixel.

Meanwhile, if the speed of the moving stage 14 fluctuates, the number of exposure points forming each of pixels P1 through P8 differs from each other depending on the fluctuation of the speed. Specifically, if two or more exposure timings are present while the moving stage 14 moves for the width of a single pixel, in other words, in an area in which exposure is performed while the moving stage is moving at a relatively low speed, each pixel is formed by two or more exposure points. If no exposure timing is present while the moving stage 14 moves for the width of a single pixel, in other words, in an area in which exposure is performed while the moving stage is moving at a relatively high speed, each pixel is not exposed to light.

In FIG. 26, when pixels P1 and P5 are formed by exposure, the moving stage 14 moves at a relatively low speed. When pixels P4 and P8 are formed by exposure, the moving stage 14 moves at a relatively high speed. When the pixels P2, P3, P6 and P7 are formed by exposure, the moving stage 14 moves at a constant speed that has been set in advance.

Therefore, it is necessary to obtain exposure point data based on the fluctuation in the speed of the moving stage as described above.

The exposure point data obtainment means 91 obtains exposure point data sets, the number of which is based on the speed fluctuation information obtained by the speed fluctuation information obtainment means 90, from a single pixel data set d in the exposure image data D. Specifically, the speed fluctuation information is, for example, information about the fluctuation of the movement distance of the moving stage 14 in the direction of the movement of the stage at a predetermined exposure timing pitch. The speed fluctuation information is set, in advance, in the speed fluctuation information obtainment means 90.

Then, the speed fluctuation information, which has been set in advance in the speed fluctuation information obtainment means 90 as described above, is output to the exposure point data obtainment means 91. For example, if the movement speed of the moving stage 14 does not fluctuate, in other words, if the movement fluctuation information is the same as the movement distance that has been set in advance, the exposure point data obtainment means 91 obtains a single exposure point data set pn (n is, for example, 1 through 8) from a single pixel data set d, as indicated by arrows in dotted lines in FIG. 27. Meanwhile, if the movement speed of the moving stage 14 fluctuates, in other words, if the movement fluctuation information is shorter or longer than the movement distance that has been set in advance, the exposure point data obtainment means 91 obtains exposure point data sets, the number of which is based on the fluctuation of the speed, from a single pixel data set d in the exposure image data D. For example, if the speed fluctuates as indicated with the arrows in solid lines in FIG. 26, three exposure point data sets p1 are obtained from a singe pixel data set d for exposure point data for forming the pixel P1 by exposure, as indicated with the arrows in solid lines in FIG. 27. Similarly, three exposure point data sets p5 are obtained from a singe pixel data set d for exposure point data for forming the pixel P5 by exposure. Further, no exposure point data for forming the pixels P4 and P8 by exposure is obtained. Further, as exposure data for forming each of pixels P2, P3, P6 and P7 by exposure, a single exposure point data set p2, p3, p6 or p7 is obtained from a single pixel data set d. Specifically, when the speed fluctuates as illustrated in FIG. 26, three exposure point data sets p1, a single exposure point data set p2, a single exposure point data set p3, three exposure point data sets p5, a single exposure point data set p6 and a single exposure point data set p7 are obtained.

Then, the exposure point data that has been obtained as described above is sequentially output to the exposure head control unit 58 based on the movement of the moving stage 14. Then, the exposure head control unit 58 outputs a control signal based on the exposure point data to the micromirrors 38 of each of the exposure heads 30. Further, the micromirrors are turned ON/OFF based on the control signal, and exposure points are formed on the substrate 12 by exposure.

According to the exposure apparatus 45 using the fourth embodiment of the present invention, speed fluctuation information indicating the fluctuation of the actual relative movement speed of the substrate 12 during exposure for forming an exposure image with respect to a predetermined relative movement speed of the substrate 12, which has been set in advance, is obtained. Further, exposure point data pn is obtained from each pixel data set d, based on the obtained speed fluctuation information, so that the number of exposure point data sets pn obtained from each pixel data d for an exposure area on the substrate 12 becomes larger as the actual relative movement speed of the substrate 12 becomes relatively lower. Therefore, it is possible to form a desirable exposure image at a desirable position on the substrate 12 without being affected by the unevenness (irregularity) of the movement speed of the moving stage 14.

In the exposure apparatus 45 of the fourth embodiment of the present invention, the action of obtaining detection position information by the detection position information obtainment means 52, the action of obtaining exposure track information based on the detection position information by the exposure track information obtainment means 54 and the action of identifying (selecting) pixel data based on the exposure track information by the exposure point data obtainment means 56 are similar to the actions performed by the components of the exposure apparatus 10 in the first embodiment of the present invention. When the exposure point data is read out from the pixel data d that has been identified (selected) as described above, the aforementioned method may be adopted.

Further, in the exposure apparatus of the second embodiment and in the exposure apparatus of the third embodiment, exposure point data may be obtained by using a method similar to the aforementioned method. In such a case, the actions till identifying (selecting) pixel data based on the exposure track information is similar to the action performed by the exposure apparatus of the second embodiment and the exposure apparatus of the third embodiment.

Further, in the exposure apparatus of the second embodiment, if the number of exposure point data set or sets to be obtained is changed based on the speed fluctuation information as in the exposure apparatus of the fourth embodiment, it is possible to correct the meandering of the moving stage 14, as illustrated in FIG. 28A, for example. Further, it is possible to perform correction in which yawing as illustrated in FIG. 28B is considered. In other words, it is possible to perform correction in which the movement posture of the substrate is considered. The term “yawing” represents a movement in which the rotation of the moving stage 14 is combined with the meandering of the moving stage 14, illustrated in FIG. 28A. As the moving stage 14 rotates as described above, the position of an image of each of the micromirrors 38 on the substrate 12 changes, and the distance of movement of the moving stage 14 in the direction of the movement of the stage at a predetermined exposure timing pitch changes. In other words, local fluctuation in speed of the moving stage 14 occurs because of the rotation. Therefore, the number of exposure point data set or sets should be changed based on the information about the fluctuation in the position of the image and the fluctuation in speed. Alternatively, the meandering component may be set to 0, and only the rotation component may be considered.

For example, as illustrated in FIG. 29A, when yawing of the stage 14 (substrate 12) occurs, if exposure timing is determined based on the distance of movement of point B, the distance of the movement of point A is not constant. Therefore, as illustrated in FIG. 29B, intervals of exposure points on the exposure track that passes through the point A are not constant. Hence, the readout pitch (sampling pitch) of the exposure point data sets on the exposure point data track information that passes through the point A should be changed based on the distance of movement of the point A.

When the readout pitch of the exposure point data on the exposure point data track is changed as described above, it is desirable that the readout pitch is adjusted at temporally identical positions (black triangles in FIG. 30) on the exposure point data track information (arrows in FIG. 30) of each of the micromirrors 38, as illustrated in FIG. 30.

Further, an exposure apparatus may be configured by using all of the first through fourth embodiments. The action of such an exposure apparatus will be briefly described with reference to the flow charts illustrated in FIGS. 31 and 32. The details of the action are similar to those of the action as described above.

First, passage position information about each of the micromirrors 38 of the DMD 36 of each of the exposure heads 30 is input to the exposure track information obtainment means 54 and set therein (step S10). Then, shift information about the moving stage 14 and the speed fluctuation information are input to the information obtainment means and the speed fluctuation information obtainment means 90, respectively, and set therein (step S12). Then, vector data representing a circuit pattern (wiring pattern) generated at the data generation apparatus 40 is input to the raster conversion processing unit 50. The vector data is converted into raster data at the raster conversion processing unit 50, and output to the exposure point data obtainment means 56. The raster data is temporarily stored, as exposure image data, by the exposure point data obtainment means 56 (step S14).

Meanwhile, when the vector data is input to the raster conversion processing unit 50 as described above, the controller 70, which controls the operation of the whole exposure apparatus 10, outputs a control signal to the movement mechanism 60. The movement mechanism 60 moves, based on the control signal, the moving stage 14 from the position illustrated in FIG. 1 to a predetermined initial position on the upstream side along the guides 20. After the moving stage 14 is once moved to the initial position, the moving stage 14 is moved in the direction of the movement of the stage at a desirable speed (step S16).

Then, the base marks 12a on the substrate 12 on the moving stage 14, which moves as described above, are photographed with the cameras 26. Further, the detection position information obtainment means 52 obtains detection position information based on the photographed image data (step S18).

Further, the detection position information obtained as described above is output from the detection position information obtainment means 52 to the exposure track information obtainment means, and shift information set by the shift information obtainment means is output to the exposure track information obtainment means. In the exposure track information obtainment means, information about the exposure track of each of the micromirrors 38 on the substrate 12 is calculated. Specifically, as described above in the explanation of the exposure apparatus of the first embodiment, the coordinate value of an intersection of a straight line connecting detection position information sets 12d that are adjacent to each other in a direction perpendicular to the scan direction and a straight line indicating the passage position information 12c of each of the micromirrors is obtained. Further, the ratio of a distance between the intersection and one of the detection position information sets 12d adjacent to the intersection in the direction perpendicular to the scan direction to a distance between the intersection and the other detection position set 12d adjacent to the intersection is obtained. Specifically, ratios a1:b1, a2:b2, a3:b3 and a4:b4 in FIG. 7 are obtained as exposure track information. The aforementioned ratios are obtained after deducting a shift amount from the detection position information obtained as described above (step S20).

The exposure track information obtainment means calculates the aforementioned ratios and obtains provisional exposure track information for each of the micromirrors 38 based on the input shift amount and passage position information about each of the micromirrors 38. The provisional exposure track information and the ratios are obtained as exposure track information, and output to the exposure point data obtainment means. The order of obtainment of the ratios and the provisional exposure track may be a reverse order. In the exposure point data obtainment means, a curved line corresponding to the exposure track information is obtained, as described above with reference to FIG. 22, and pixel data on the curved line in the exposure image data D is identified (selected) as pixel data to be used for exposure (step S24). Then, the speed fluctuation information obtained by the speed fluctuation information obtainment means is input to the exposure point data obtainment means. As described above in the explanation of the exposure apparatus of the fourth embodiment, exposure point data sets, the number of which is based on the speed fluctuation information, are obtained from each of pixel data sets in the exposure image data (step S26). At this time, it is desirable that expansion/shrinkage of the substrate 12 in the scan direction is considered in addition to the speed fluctuation information. Specifically, it is desirable that the number of the exposure point data sets is determined by considering the length of the passage position information about the micromirror 38 for each area divided by the detection position information 12d of the substrate 12.

Then, 90-degree rotation processing or transposition transformation using a matrix is performed on a string of exposure point data sets for each of the micromirrors 38, obtained as described above. Then, as illustrated in FIG. 13, frame data 1 through m corresponding to each position of each of the exposure heads 30 with respect to the substrate 12 is generated (step S28). The frame data 1 through m is sequentially output to each of the exposure heads 30 based on the movement of the moving stage 14. Then, each of the exposure heads 30 forms an exposure image based on the frame data on the substrate 12 (step S30). When all of the frame data sets are input to the exposure heads 30 and exposure ends, the moving stage 14 is moved to the initial position again (step S32). If there is a next substrate 12 to be processed, the processed substrate is replaced with the next substrate 12. Then, processing from step S16 is performed again. If there is no substrate 12 to be processed next, processing ends (step S34).

The exposure point data obtainment means in the aforementioned embodiments should include both of the drawing point data track obtainment means and the drawing point data obtainment means.

Further, in the aforementioned embodiments, an exposure apparatus including a DMD as the spatial light modulation device has been described. However, a transmission-type spatial light modulation device may be used instead of a reflection-type spatial light modulation device, such as the DMD.

Further, in the aforementioned embodiments, a so-called flat-bed-type exposure apparatus was used as an example of the exposure apparatus. However, a so-called outer-drum-type exposure apparatus (or inner-drum-type exposure apparatus) including a drum around which a photosensitive material is wound may be used.

Further, it is not necessary that the substrate 12, which is an exposure object in the aforementioned embodiments, is a printed circuit board. The substrate 12 may be a substrate for a flat panel display. In such a case, a pattern may be a pattern forming a color filter and a black matrix of a liquid crystal display or the like, or a semiconductor circuit of a TFT or the like. Further, the shape of the substrate 12 may be a sheet form or a lengthy object (flexible substrate or the like).

Further, the drawing method and apparatus in the embodiments of the present invention may be applied to drawing at an inkjet printer or the like. For example, a drawing point formed by ejected ink may be formed in a manner similar to the present invention. Specifically, the drawing point formation area of the present invention may be considered as an area to which ink ejected from each nozzle of the inkjet printer attaches.

Further, as the drawing track information in the embodiments of the present invention, an actual drawing track of a drawing point formation area on a substrate may be used. Alternatively, information approximating the actual drawing track of a drawing point formation area on the substrate may be used as the drawing track information. Alternatively, information obtained by estimating an actual drawing track of a drawing point formation area on the substrate may be used as the drawing track information.

Further, in the embodiments of the present invention, the number of drawing point data sets may be increased as the length of the drawing track becomes longer, and the number of drawing point data sets may be reduced as the length of the drawing track becomes shorter. In such a manner, the number of drawing point data sets obtained from each pixel data set forming image data may be changed based on the length represented by the drawing track information.

Further, the image space in the embodiments of the present invention may be a coordinate space based on an image to be drawn on a substrate or an image that has been drawn on the substrate.

As described above, the information about the drawing track of the drawing point formation area in the embodiments of the present invention may be considered both as information about a drawing track in the coordinate space of the substrate and as information about a drawing track in the coordinate space of the image. The coordinate of the substrate and the coordinate of the image are different from each other in some cases.

In the aforementioned embodiments, a single exposure point data track may be obtained for every two or more micromirrors (beams). For example, an exposure point data track may be obtained for every group of a plurality of beams condensed by a single microlens forming a microlens array.

Further, data readout pitch information may be attached to each of exposure point data track information sets. In such a case, the pitch information may include a sampling rate (a ratio of a minimum movement distance of a beam for switching drawing point data sets (the distance is the same for all of the beams if no correction is performed) to the resolution of an image (pixel pitch)). Further, information about the adjustment of the exposure point data, the adjustment associated with correction with respect to the length of the exposure track, may be included in the pitch information. Further, in addition to the information about the adjustment of the exposure point data, the adjustment position may be included in the pitch information, and the adjustment position may be attached to the information about the exposure track. Further, as each exposure point data track information set, all of data readout addresses (x, y) (readout addresses in a chronological order) corresponding to each frame may be provided.

Further, the direction along the data readout track in the image data may be the same as the direction of the sequence of the addresses in a memory. For example, in the example illustrated in FIG. 9, image data is stored in the memory in such a manner that the transverse direction (horizontal direction) of the image data becomes the same as the direction of the sequence of the addresses. In this case, image data for each beam can be read out at a high speed. Further, a DRAM may be used as the memory. However, any kind of memory may be used as long as stored data can be sequentially read out at a high speed in the direction of the sequence of the addresses. For example, a high-speed random access memory, such as a SRAM (Static Random Access Memory), may be used. In this case, the direction of the sequence of the addresses on the memory may be defined as a direction along the exposure track, and data may be read out in the direction of the sequence. Further, the memory may be wired or programmed in advance so that data is read out along the direction of the sequence of the addresses. Further, the direction of the sequence of the addresses may be a direction along a path through which a plurality of consecutive bits are read out together.

1-64. (canceled)

53. A drawing point data obtainment method for obtaining drawing point data, wherein the drawing point data is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object, the method comprising the steps of:
obtaining information about a drawing point data track of the drawing point formation area in original image data of the image; and
obtaining, based on the obtained information about the drawing point data track, a plurality of drawing point data sets corresponding to the drawing point data track from the image data.

54. A drawing point data obtainment method for obtaining drawing point data, wherein the drawing point data is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object, the method comprising the steps of:
obtaining information about a drawing track of the drawing point formation area on the drawing object, the drawing track being a drawing track when the image is drawn;
obtaining, based on the obtained information about the drawing track, information about a drawing point data track of the drawing point formation area in original image data of the image; and
obtaining, based on the obtained information about the drawing point data track, a plurality of drawing point data sets corresponding to the drawing point data track from the image data.

55. A drawing point data obtainment method for obtaining drawing point data, wherein the drawing point data is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object, the method comprising the steps of:
obtaining information about a drawing track of the drawing point formation area in an image space on the drawing object;
obtaining, based on the obtained information about the drawing track, information about a drawing point data track of the drawing point formation area in original image data of the image; and
obtaining, based on the obtained information about the drawing point data track, a plurality of drawing point data sets corresponding to the drawing point data track from the image data.

56. A drawing method for drawing an image on a drawing object, the method comprising the steps of:
relatively moving a drawing point formation area, in which a drawing point is formed based on drawing point data, with respect to the drawing object; and
sequentially forming, based on the movement of the drawing point formation area, the drawing points on the drawing object, wherein information about a drawing point data track of the drawing point formation area in original image data of the image is obtained, and wherein a plurality of drawing point data sets corresponding to the drawing point data track are obtained, based on the obtained information about the drawing point data track, from the image data, and wherein the drawing points are formed on the drawing object based on the obtained drawing point data by use of the drawing point formation area.

57. A drawing method for drawing an image on a drawing object, the method comprising the steps of:
relatively moving a drawing point formation area, in which a drawing point is formed based on drawing point data, with respect to the drawing object; and
sequentially forming, based on the movement of the drawing point formation area, the drawing points on the drawing object, wherein information about a drawing track of the drawing point formation area on the drawing object is obtained, the drawing track being a drawing track when the image is drawn, and wherein information about a drawing point data track of the drawing point formation area in original image data of the image is obtained based on the obtained information about the drawing track, and wherein a plurality of drawing point data sets corresponding to the drawing point data track are obtained, based on the obtained information about the drawing point data track, from the image data, and wherein the drawing points are formed on the drawing object based on the obtained drawing point data by use of the drawing point formation area.

58. A drawing method for drawing an image on a drawing object, the method comprising the steps of:
relatively moving a drawing point formation area, in which a drawing point is formed based on the drawing point data, with respect to the drawing object; and
sequentially forming, based on the movement of the drawing point formation area, the drawing points on the drawing object, wherein information about a drawing track of the drawing point formation area in an image space on the drawing object is obtained, and wherein information about a drawing point data track of the drawing point formation area in original image data of the image is obtained based on the obtained information about the drawing track, and wherein a plurality of drawing point data sets corresponding to the drawing point data track are obtained, based on the obtained information about the drawing point data track, from the image data, and wherein the drawing points are formed on the drawing object based on the obtained drawing point data by use of the drawing point formation area.

59. A drawing method, as defined in claim 57, wherein detection position information indicating the positions of a plurality of base marks and/or base portions present at predetermined positions on the drawing object is obtained by detecting the plurality of base marks and/or base portions, and wherein the information about the drawing track is obtained based on the obtained detection position information.

60. A drawing method, as defined in claim 58, wherein detection position information indicating the positions of a plurality of base marks and/or base portions present at predetermined positions on the drawing object is obtained by detecting the plurality of base marks and/or base portions, and wherein the information about the drawing track is obtained based on the obtained detection position information.

61. A drawing method, as defined in claim 57, wherein shift information about an actual relative movement direction and/or movement posture of the drawing object at the time of drawing the image with respect to a predetermined relative movement direction and/or movement posture of the drawing object is obtained, the predetermined relative movement direction and/or movement posture having been set in advance, and wherein the information about the drawing track is obtained based on the obtained shift information.

62. A drawing method, as defined in claim 58, wherein shift information about an actual relative movement direction and/or movement posture of the drawing object at the time of drawing the image with respect to a predetermined relative movement direction and/or movement posture of the drawing object is obtained, the predetermined relative movement direction and/or movement posture having been set in advance, and wherein the information about the drawing track is obtained based on the obtained shift information.

63. A drawing method, as defined in claim 59, wherein shift information about an actual relative movement direction and/or movement posture of the drawing object at the time of drawing the image with respect to a predetermined relative movement direction and/or movement posture of the drawing object is obtained, the predetermined relative movement direction and/or movement posture having been set in advance, and wherein the information about the drawing track is obtained based on the obtained shift information and the detection position information.

64. A drawing method, as defined in claim 60, wherein shift information about an actual relative movement direction and/or movement posture of the drawing object at the time of drawing the image with respect to a predetermined relative movement direction and/or movement posture of the drawing object is obtained, the predetermined relative movement direction and/or movement posture having been set in advance, and wherein the information about the drawing track is obtained based on the obtained shift information and the detection position information.

65. A drawing method, as defined in claim 57, wherein the number of drawing point data sets obtained from each pixel data set forming the image data is changed based on the length of a drawing track indicated by the information about the drawing track.

66. A drawing method, as defined in claim 58, wherein the number of drawing point data sets obtained from each pixel data set forming the image data is changed based on the length of a drawing track indicated by the information about the drawing track.

67. A drawing method, as defined in claim 56, wherein speed fluctuation information indicating the fluctuation of an actual relative movement speed of the drawing object at the time of drawing the image with respect to a predetermined relative movement speed of the drawing object is obtained, the predetermined relative movement speed having been set in advance, and wherein the drawing point data is obtained, based on the obtained speed fluctuation information, from each pixel data set forming the image data in such a manner that a greater number of drawing point data sets are obtained from the pixel data set for a drawing area on the drawing object as the actual relative movement speed of the drawing object is relatively slower.

68. A drawing method, as defined in claim 57, wherein speed fluctuation information indicating the fluctuation of an actual relative movement speed of the drawing object at the time of drawing the image with respect to a predetermined relative movement speed of the drawing object is obtained, the predetermined relative movement speed having been set in advance, and wherein the drawing point data is obtained, based on the obtained speed fluctuation information, from each pixel data set forming the image data in such a manner that a greater number of drawing point data sets are obtained from the pixel data set for a drawing area on the drawing object as the actual relative movement speed of the drawing object is relatively slower.

69. A drawing method, as defined in claim 58, wherein speed fluctuation information indicating the fluctuation of an actual relative movement speed of the drawing object at the time of drawing the image with respect to a predetermined relative movement speed of the drawing object is obtained, the predetermined relative movement speed having been set in advance, and wherein the drawing point data is obtained, based on the obtained speed fluctuation information, from each pixel data set forming the image data in such a manner that a greater number of drawing point data sets are obtained from the pixel data set for a drawing area on the drawing object as the actual relative movement speed of the drawing object is relatively slower.

70. A drawing method, as defined in claim 56, wherein the drawing is performed by use of a plurality of drawing point formation areas, and wherein the drawing point data is obtained for each of the drawing point formation areas.

71. A drawing method, as defined in claim 57, wherein the drawing is performed by use of a plurality of drawing point formation areas, and wherein the drawing point data is obtained for each of the drawing point formation areas.

72. A drawing method, as defined in claim 58, wherein the drawing is performed by use of a plurality of drawing point formation areas, and wherein the drawing point data is obtained for each of the drawing point formation areas.

73. A drawing method, as defined in claim 56, wherein the drawing point formation area is a beam spot formed by a spatial light modulation device.

74. A drawing method, as defined in claim 57, wherein the drawing point formation area is a beam spot formed by a spatial light modulation device.

75. A drawing method, as defined in claim 58, wherein the drawing point formation area is a beam spot formed by a spatial light modulation device.

76. A drawing method, as defined in claim 56, wherein a pitch component is attached to the information about the drawing point data track, the pitch component indicating an obtainment pitch of the drawing point data.

77. A drawing method, as defined in claim 57, wherein a pitch component is attached to the information about the drawing point data track, the pitch component indicating an obtainment pitch of the drawing point data.

78. A drawing method, as defined in claim 58, wherein a pitch component is attached to the information about the drawing point data track, the pitch component indicating an obtainment pitch of the drawing point data.

79. A drawing method, as defined in claim 56, wherein a plurality of drawing point formation areas are present, and wherein a single information set about the drawing point data track is obtained for every two or more drawing point formation areas.

80. A drawing method, as defined in claim 57, wherein a plurality of drawing point formation areas are present, and wherein a single information set about the drawing point data track is obtained for every two or more drawing point formation areas.

81. A drawing method, as defined in claim 58, wherein a plurality of drawing point formation areas are present, and wherein a single information set about the drawing point data track is obtained for every two or more drawing point formation areas.

82. A drawing method, as defined in claim 56, wherein a plurality of drawing point formation areas are two-dimensionally arranged.

83. A drawing method, as defined in claim 57, wherein a plurality of drawing point formation areas are two-dimensionally arranged.

84. A drawing method, as defined in claim 58, wherein a plurality of drawing point formation areas are two-dimensionally arranged.

85. A drawing point data obtainment apparatus for obtaining drawing point data, wherein the drawing point data is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object, the apparatus comprising:
a drawing point data track information obtainment means for obtaining information about a drawing point data track of the drawing point formation area in original image data of the image; and
a drawing point data obtainment means for obtaining, based on the information about the drawing point data track obtained by the drawing point data track information obtainment means, a plurality of drawing point data sets corresponding to the drawing point data track from the image data.

86. A drawing point data obtainment apparatus for obtaining drawing point data, wherein the drawing point data is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object, the apparatus comprising:
a drawing track information obtainment means for obtaining information about a drawing track of the drawing point formation area on the drawing object, the drawing track being a drawing track when the image is drawn;
a drawing point data track information obtainment means for obtaining, based on the information about the drawing track obtained by the drawing track information obtainment means, information about a drawing point data track of the drawing point formation area in original image data of the image; and
a drawing point data obtainment means for obtaining, based on the information about the drawing point data track obtained by the drawing point data track information obtainment means, a plurality of drawing point data sets corresponding to the drawing point data track from the image data.

87. A drawing point data obtainment apparatus for obtaining drawing point data, wherein the drawing point data is used when an image is drawn on a drawing object by relatively moving a drawing point formation area, in which a drawing point is formed based on the drawing point data, with respect to the drawing object and by sequentially forming, based on the movement of the drawing point formation area, the drawing points on the drawing object, the apparatus comprising:
a drawing track information obtainment means for obtaining information about a drawing track of the drawing point formation area in an image space on the drawing object;
a drawing point data track information obtainment means for obtaining, based on the information about the drawing track obtained by the drawing track information obtainment means, information about a drawing point data track of the drawing point formation area in original image data of the image; and
a drawing point data obtainment means for obtaining, based on the information about the drawing point data track obtained by the drawing point data track information obtainment means, a plurality of drawing point data sets corresponding to the drawing point data track from the image data.

88. A drawing apparatus comprising:
a drawing means for drawing an image on a drawing object by relatively moving a drawing point formation area, in which a drawing point is formed based on drawing point data, with respect to the drawing object and by sequentially forming, based on the movement of the drawing point formation area, the drawing points on the drawing object;
a drawing point data track information obtainment means for obtaining information about a drawing point data track of the drawing point formation area in original image data of the image; and
a drawing point data obtainment means for obtaining, based on the information about the drawing point data track obtained by the drawing point data track information obtainment means, a plurality of drawing point data sets corresponding to the drawing point data track from the image data, wherein the drawing means forms, based on the drawing point data obtained by the drawing point data obtainment means, the drawing points on the drawing object by use of the drawing point formation area.

89. A drawing apparatus comprising:
a drawing means for drawing an image on a drawing object by relatively moving a drawing point formation area, in which a drawing point is formed based on drawing point data, with respect to the drawing object and by sequentially forming, based on the movement of the drawing point formation area, the drawing points on the drawing object;
a drawing track information obtainment means for obtaining information about a drawing track of the drawing point formation area on the drawing object, the drawing track being a drawing track when the image is drawn;
a drawing point data track information obtainment means for obtaining, based on the information about the drawing track obtained by the drawing track information obtainment means, information about a drawing point data track of the drawing point formation area in original image data of the image; and
a drawing point data obtainment means for obtaining, based on the information about the drawing point data track obtained by the drawing point data track information obtainment means, a plurality of drawing point data sets corresponding to the drawing point data track from the image data, wherein the drawing means forms, based on the drawing point data obtained by the drawing point data obtainment means, the drawing points on the drawing object by use of the drawing point formation area.

90. A drawing apparatus comprising:
a drawing means for drawing an image on a drawing object by relatively moving a drawing point formation area, in which a drawing point is formed based on drawing point data, with respect to the drawing object and by sequentially forming, based on the movement of the drawing point formation area, the drawing points on the drawing object;
a drawing track information obtainment means for obtaining information about a drawing track of the drawing point formation area in an image space on the drawing object;
a drawing point data track information obtainment means for obtaining, based on the information about the drawing track obtained by the drawing track information obtainment means, information about a drawing point data track of the drawing point formation area in original image data of the image; and
a drawing point data obtainment means for obtaining, based on the information about the drawing point data track obtained by the drawing point data track information obtainment means, a plurality of drawing point data sets corresponding to the drawing point data track from the image data, wherein the drawing means forms, based on the drawing point data obtained by the drawing point data obtainment means, the drawing points on the drawing object by use of the drawing point formation area.

91. A drawing apparatus, as defined in claim 89, further comprising:
a position information detection means for obtaining detection position information indicating the positions of a plurality of base marks and/or base portions present at predetermined positions on the drawing object by detecting the plurality of base marks and/or base portions, wherein the drawing track information obtainment means obtains, based on the detection position information obtained by the position information detection means, the information about the drawing track.

92. A drawing apparatus, as defined in claim 90, further comprising:
a position information detection means for obtaining detection position information indicating the positions of a plurality of base marks and/or base portions present at predetermined positions on the drawing object by detecting the plurality of base marks and/or base portions, wherein the drawing track information obtainment means obtains, based on the detection position information obtained by the position information detection means, the information about the drawing track.

93. A drawing apparatus, as defined in claim 89, further comprising:
a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance, wherein the drawing point track information obtainment means obtains, based on the shift information obtained by the shift information obtainment means, the information about the drawing track.

94. A drawing apparatus, as defined in claim 90, further comprising:
a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance, wherein the drawing point track information obtainment means obtains, based on the shift information obtained by the shift information obtainment means, the information about the drawing track.

95. A drawing apparatus, as defined in claim 91, further comprising:
a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance, wherein the drawing point track obtainment means obtains, based on the shift information obtained by the shift information obtainment means and the detection position information obtained by the position information detection means, the information about the drawing track.

96. A drawing apparatus, as defined in claim 92, further comprising:
a shift information obtainment means for obtaining shift information about an actual relative movement direction and/or movement posture of the drawing object at the time of drawing the image with respect to a predetermined relative movement direction and/or movement posture of the drawing object, the predetermined relative movement direction and/or movement posture having been set in advance, wherein the drawing point track obtainment means obtains, based on the shift information obtained by the shift information obtainment means and the detection position information obtained by the position information detection means, the information about the drawing track.

97. A drawing apparatus, as defined in claim 89, wherein the drawing point data obtainment means changes, based on a length indicated by the information about the drawing track, the number of drawing point data sets obtained from each pixel data set forming the image data.

98. A drawing apparatus, as defined in claim 90, wherein the drawing point data obtainment means changes, based on a length indicated by the information about the drawing track, the number of drawing point data sets obtained from each pixel data set forming the image data.

99. A drawing apparatus, as defined in claim 87, further comprising:
a speed fluctuation information obtainment means for obtaining speed fluctuation information indicating the fluctuation of an actual relative movement speed of the drawing object at the time of drawing the image with respect to a predetermined relative movement speed of the drawing object, the predetermined relative movement speed having been set in advance, wherein the drawing point data obtainment means obtains, based on the speed fluctuation information obtained by the speed fluctuation information obtainment means, the drawing point data from each pixel data set forming the image data in such a manner that a greater number of drawing point data sets are obtained from the pixel data set for a drawing area on the drawing object as the actual relative movement speed of the drawing object is relatively slower.

100. A drawing apparatus, as defined in claim 89, further comprising:
a speed fluctuation information obtainment means for obtaining speed fluctuation information indicating the fluctuation of an actual relative movement speed of the drawing object at the time of drawing the image with respect to a predetermined relative movement speed of the drawing object, the predetermined relative movement speed having been set in advance, wherein the drawing point data obtainment means obtains, based on the speed fluctuation information obtained by the speed fluctuation information obtainment means, the drawing point data from each pixel data set forming the image data in such a manner that a greater number of drawing point data sets are obtained from the pixel data set for a drawing area on the drawing object as the actual relative movement speed of the drawing object is relatively slower.

101. A drawing apparatus, as defined in claim 90, further comprising:
a speed fluctuation information obtainment means for obtaining speed fluctuation information indicating the fluctuation of an actual relative movement speed of the drawing object at the time of drawing the image with respect to a predetermined relative movement speed of the drawing object, the predetermined relative movement speed having been set in advance, wherein the drawing point data obtainment means obtains, based on the speed fluctuation information obtained by the speed fluctuation information obtainment means, the drawing point data from each pixel data set forming the image data in such a manner that a greater number of drawing point data sets are obtained from the pixel data set for a drawing area on the drawing object as the actual relative movement speed of the drawing object is relatively slower.

102. A drawing apparatus, as defined in claim 88, wherein a plurality of drawing point formation areas are present, and wherein the drawing point data obtainment means obtains the drawing point data for each of the drawing point formation areas.

103. A drawing apparatus, as defined in claim 90, wherein a plurality of drawing point formation areas are present, and wherein the drawing point data obtainment means obtains the drawing point data for each of the drawing point formation areas.

104. A drawing apparatus, as defined in claim 88, wherein a plurality of drawing point formation areas are present, and wherein the drawing point data obtainment means obtains the drawing point data for each of the drawing point formation areas.

105. A drawing apparatus, as defined in claim 89, further comprising:
a spatial light modulation device for forming the drawing point formation area.

106. A drawing apparatus, as defined in claim 90, further comprising:
a spatial light modulation device for forming the drawing point formation area.

107. A drawing apparatus, as defined in claim 88, further comprising:
a spatial light modulation device for forming the drawing point formation area.

108. A drawing apparatus, as defined in claim 89, wherein a pitch component is attached to the information about the drawing point data track, the pitch component indicating an obtainment pitch of the drawing point data.

109. A drawing apparatus, as defined in claim 90, wherein a pitch component is attached to the information about the drawing point data track, the pitch component indicating an obtainment pitch of the drawing point data.

110. A drawing apparatus, as defined in claim 88, wherein a pitch component is attached to the information about the drawing point data track, the pitch component indicating an obtainment pitch of the drawing point data.

111. A drawing apparatus, as defined in claim 89, wherein a plurality of drawing point formation areas are present, and wherein the drawing point data track information obtainment means obtains a single information set about the drawing point data track for every two or more drawing point formation areas.

112. A drawing apparatus, as defined in claim 90, wherein a plurality of drawing point formation areas are present, and wherein the drawing point data track information obtainment means obtains a single information set about the drawing point data track for every two or more drawing point formation areas.

113. A drawing apparatus, as defined in claim 88, wherein a plurality of drawing point formation areas are present, and wherein the drawing point data track information obtainment means obtains a single information set about the drawing point data track for every two or more drawing point formation areas.

114. A drawing apparatus, as defined in claim 88, wherein the plurality of drawing point formation areas are two-dimensionally arranged.

115. A drawing apparatus, as defined in claim 89, wherein the plurality of drawing point formation areas are two-dimensionally arranged.

116. A drawing apparatus, as defined in claim 90, wherein the plurality of drawing point formation areas are two-dimensionally arranged.
